(19) United States
(12) Patent Application Publication
(10) Pub. No.: US 2015/0083661 A1
(43) Pub. Date: Mar. 26, 2015

(54) METHODS AND SYSTEMS FOR SEWAGE SLUDGE TREATMENT

(71) Applicants: Bart Pieper, Chicago, IL (US); Michelle Gina Gothard, Royston Hertfordshire (GB)

(72) Inventors: Bart Pieper, Chicago, IL (US); Michelle Gina Gothard, Royston Hertfordshire (GB)

(21) Appl. No.: 14/359,841

(22) PCT Filed: Jul. 13, 2012
(86) PCT No.: PCT/US2012/046620

§ 371 Date: Nov. 12, 2014

Related U.S. Application Data
(60) Provisional application No. 61/563,986, filed on Nov. 28, 2011.

(51) Int. Cl. C02F 11/04; B05B 7/04

(52) U.S. Cl. CPC C02F 11/04; B05B 7/0483; B05B 7/0408; C02F 2203/006
USPC 210/603; 210/601; 210/620; 210/259

(57) ABSTRACT

The present invention provides methods for increasing soluble chemical oxygen demand (sCOD) in sewage sludge. These methods include passing the sewage sludge through one or more devices that contains (a) a hollow body provided with a straight-through passage of substantially constant cross-section, the passage having an inlet end and an outlet end for the entry and discharge respectively of the sewage sludge, (b) a transport fluid nozzle substantially circumscribing and opening into the passage intermediate the inlet and outlet ends thereof, (c) a transport fluid inlet communicating with the transport fluid nozzle for the introduction of a transport fluid, and (d) a mixing chamber being formed within the passage downstream of the transport fluid nozzle. The sewage sludge is then passed through a digester.

### FIELD OF INVENTION

The present invention provides, inter alia, methods and systems for treating sewage sludge.

### BACKGROUND OF THE INVENTION

Sewage sludge generally contains considerable amounts of organic substances. Digestion/fermentation is a widely used process for breaking down biodegradable material in e.g., sewage sludge, to manage waste. Most of the waste treatment plants in the United States use an aerobic system, because the initial capital costs for an aerobic system are lower. However, the industry is rapidly becoming aware of the fact that they are foregoing revenue by not capturing methane with an anaerobic system.

The performance of the anaerobic digestion process is dependent, inter alia, on the biodegradability of the material used as a substrate with the rate limiting step of the process being the initial hydrolysis stage (Appels et al., 2008, Abelleira et al., 2011, Claire Bougrier et al., 2008, Erden & Filibeli, 2010, Bouallagui et al., 2010). Digestion pre-treatment technologies for anaerobic digestion are, therefore, applied to disintegrate the sludges to release the organic material enclosed in bacterial flocs and cells (Valo et al., 2004), thus increasing the biodegradability of the sludge and making the substrate more accessible for the anaerobic microbial communities.

Sludge pre-treatments may include mechanical, thermal, chemical, biological or a combination (Bougrier et al., 2007, Appels et al., 2008, Pérez-Elvira et al., 2006). Despite the research in the field of sludge pretreatment, there still exists a need for improving mass reduction, energy production, and improved dewatering properties of the fermented sludge. This invention is directed to meeting these and other needs.

### SUMMARY OF THE INVENTION

One embodiment of the present invention is a method of increasing soluble chemical oxygen demand (sCOD) in sewage sludge. This method comprises:
(i) passing the sewage sludge through one or more devices that comprise:
   (a) a hollow body provided with a straight-through passage of substantially constant cross-section, the passage having an inlet end and an outlet end for the entry and discharge, respectively, of the sewage sludge,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle, wherein the sCOD of the sewage sludge is increased by up to 3,000-4,000% after step (i) compared to the sCOD of the sewage sludge prior to step (i); and
   (ii) passing the sewage sludge from step (i) through a digester.

Another embodiment of the present invention is a method of providing a waste water stream with a sCOD level that is increased by at least about 100% compared to a waste water stream in the absence of step (i) to an anaerobic digester. This method comprises:
(i) passing the waste water stream through one or more devices that comprise:
   (a) a hollow body provided with a straight-through passage of substantially constant cross-section, the passage having an inlet end and an outlet end for the entry and discharge respectively of the waste water,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water stream in the mixing chamber by the introduction of the transport fluid through the transport fluid nozzle, wherein the sCOD of the waste water stream is increased at least about 100% compared to a waste water stream in the absence of step (i); and
(ii) providing the waste water from step (i) to the anaerobic digester.

Yet another embodiment of the present invention is a method of increasing methane production in an anaerobic waste water processing system. This method comprises:
(i) providing (a) a waste water processing plant comprising a primary settling tank, a secondary settling tank, and an anaerobic digester, each of which is directly or indirectly in fluid communication and (b) one or more devices disposed within the waste water processing plant;
(ii) passing the waste water through the one or more devices, each device comprising:
   (a) a hollow body provided with a straight-through passage of substantially constant cross-section, the passage having an inlet end and an outlet end for the entry and discharge respectively of the waste water,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water flow in the mixing chamber by the introduction of the transport fluid through the transport fluid nozzle, wherein organic material in the waste water is substantially disintegrated;

(iii) passing the waste water from step (ii) through the anaerobic digester; and
(iv) collecting methane produced in the anaerobic digester, wherein the amount of methane collected is at least 30% greater compared to a waste water processing plant without the devices.

An additional embodiment of the present invention is a system for treating sewage sludge. This system comprises:
(i) a waste water processing plant comprising a primary settling tank, a secondary settling tank, and an anaerobic digester, each of which is directly or indirectly in fluid communication and four devices disposed within the waste water processing plant, each device comprising:
   (a) a hollow body provided with a straight-through passage of substantially constant cross-section, the passage having an inlet end and an outlet end for the entry and discharge respectively of the sewage sludge,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle, wherein the devices increase the soluble chemical oxygen demand (sCOD) in the sewage sludge by up to 3,000-4,000% compared to a system in the absence of the device(s) prior to passing the sewage sludge to the digester.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a cross sectional elevation of a device according to the present invention. Like numerals of reference have been used for like parts throughout the specification.

FIG. 2 is a cross sectional elevation of a device according to the present invention with end views shown as FIGS. 2-1 and 2-2 as taken along lines 2-1 and 2-2 therein, respectively.

FIG. 3 is a cross sectional elevation of a device according to the present invention with end views shown as FIGS. 3-1 and 3-2 as taken along lines 3-1 and 3-2 therein, respectively.

FIG. 4 is a cross sectional elevation of a third embodiment with end views shown as FIGS. 4-1 and 4-2 as taken along lines 4-1 and 4-2 therein, respectively.

FIG. 5 shows a process diagram of one exemplary system according to this invention.

FIG. 6 shows a flow chart of one exemplary system according to this invention. Each trapezoidal shape with “X” inside represents one to four devices arranged in-line. It is preferred that the devices are at positions A, D, and F.

FIG. 7 shows the chemical oxygen demand (COD) profile of a 1% blended sludge. The graph on the left side of the dotted line shows the amount of COD per number of devices (e.g., PDX reactors) in operation (numbers on the x-axis). The first measurement point on the left hand side of the graph is for pump-only operation (the pump is located upstream of the first PDX reactor). The graph on the right side of the dotted line shows the results of experiments in which 4 devices (e.g., PDX reactors) according to the present invention are used, and the numbers in the x-axis represent temperature measured at the exit of the last PDX reactor in degrees Celsius, as the steam supply to the units is increased. The scale on the y-axis is mg/L.

FIG. 8 shows the COD profile of a 5% waste activated sludge. The left side of the graph shows the effect of increasing the number of devices on the COD. The numbers on the x-axis on the left side of the dotted line in the graph indicate the number of devices used. The graph on the right side of the dotted line shows the effect of using 4 devices and increasing the steam supply to them, thereby further increasing the temperature of the waste activated sludge. The results show how the final exit temperature, as measured after the 4th PDX reactor, correlates to the COD. The numbers in the x-axis on the right side of the dotted line represent temperature in degrees Celsius. The scale of the y-axis is mg/L.

FIG. 9 (Fang et. Al, 1995) shows the average COD removal efficiency (9A) and the average methane production rate (9B) at each COD loading condition. The figures show that the COD removal efficiency was 97-99% for loading rate up to 23 g-COD/L·day, which corresponds to 11,500 mg/L of COD in the wastewater.

FIG. 10 shows a comparison of the performance achieved with 3 devices (e.g., PDX reactors) of the invention using low intensity (80-84 L·min⁻¹) pre-treatment in different sludges.

FIG. 11 shows normalized sCOD comparison in thickened WAS (A), primary sludge (B), digested sludge (C) and unthickened WAS (D) after different pre-treatments operated at 8 bars. Low intensity (80-84 L·min⁻¹), medium intensity (60 L·min⁻¹), high intensity (36-38 L·min⁻¹). The given temperature changes correspond to the difference between the inlet and the final effluent. “TS” indicates for total solids.

FIG. 12 shows a comparison of the degree of disintegration achieved in digested sludge, unthickened and thickened waste activated sludge (WAS) after different pre-treatments. TWAS indicates thickened waste activated sludge.

FIG. 13 shows normalized methane daily production at atmospheric pressure produced in the batch anaerobic digesters. (The values given are averages between the replicates).

FIG. 14 shows percentage of methane in the biogas produced in the batch anaerobic digesters. (The values given are averages between the replicates).

FIG. 15 shows capillary suction time (CST) of the sludges after the batch anaerobic digestion.

FIG. 16 shows comparison of the degree of disintegration (DD) as a function of the specific energy applied with a device (e.g., PDX reactors) according to the present invention as a pre-treatment for different sludges.

FIG. 17 shows the degree of disintegration of TWAS as a function of the specific energy applied using a device (e.g., PDX reactors) of the present invention and comparison with two ultrasound pre-treatments applied for waste activated sludge.

FIG. 18 shows the degree of disintegration of TWAS as a function of the specific energy applied using a device (e.g., PDX reactors) of the present invention and comparison with two ultrasound pre-treatments applied for waste activated sludge.

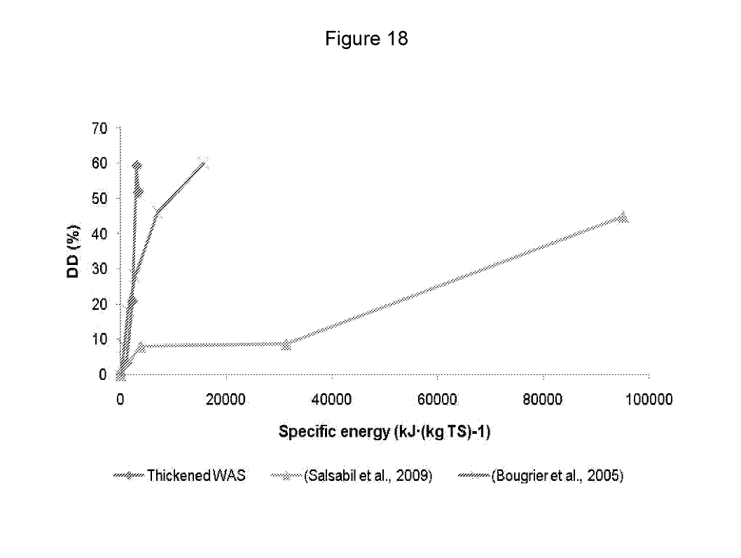

FIG. 19 shows sCOD comparison in thickened WAS after different pre-treatments using the indicated devices (e.g., PDX reactors) operated at 8 bar and low intensity (80-84 L·min⁻¹). The given temperatures correspond to the final effluent.

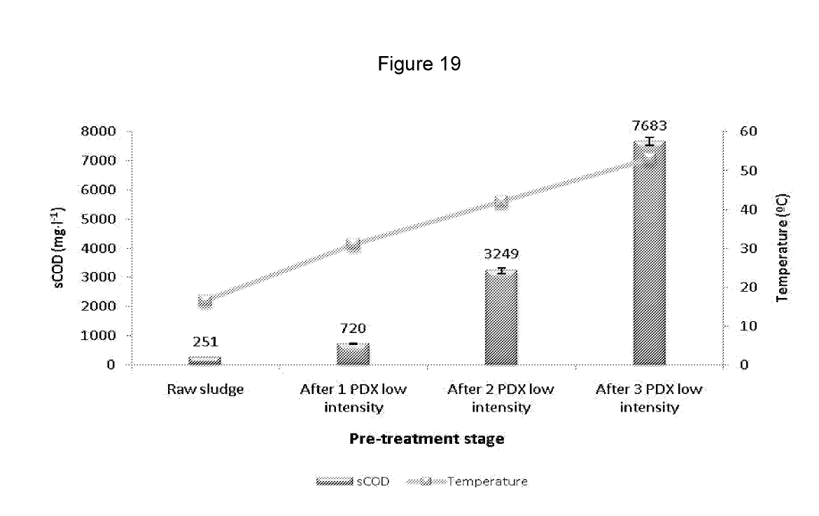

FIG. 20 shows sCOD comparison in primary sludge after different pre-treatments using the indicated devices (e.g., PDX reactors) operated at 8 bar. Low intensity (80-84 L·min⁻¹), medium intensity (60 L·min⁻¹). The given temperatures correspond to the final effluent.

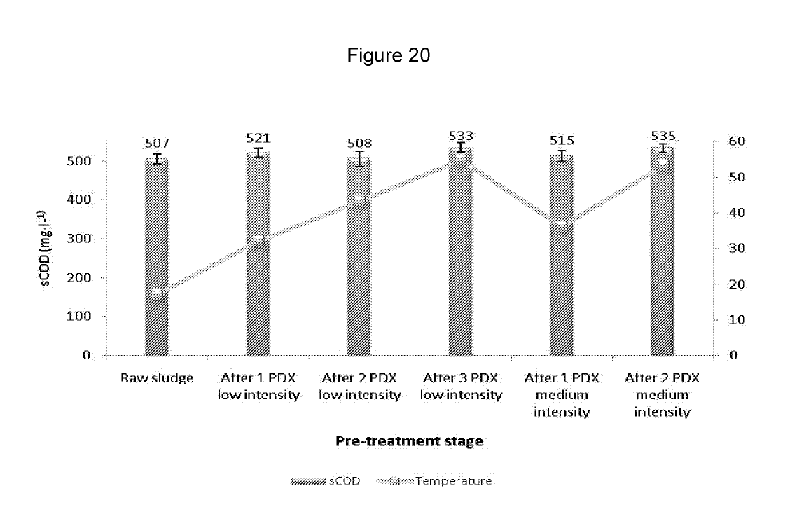

FIG. 21 shows sCOD comparison in digested sludge after different pre-treatments using the indicated devices (e.g., PDX reactors) operated at 8 bar. Low intensity (80-84 L·min⁻¹), medium intensity (60 L·min⁻¹), high intensity (38 L·min⁻¹). The given temperatures correspond to the final effluent.

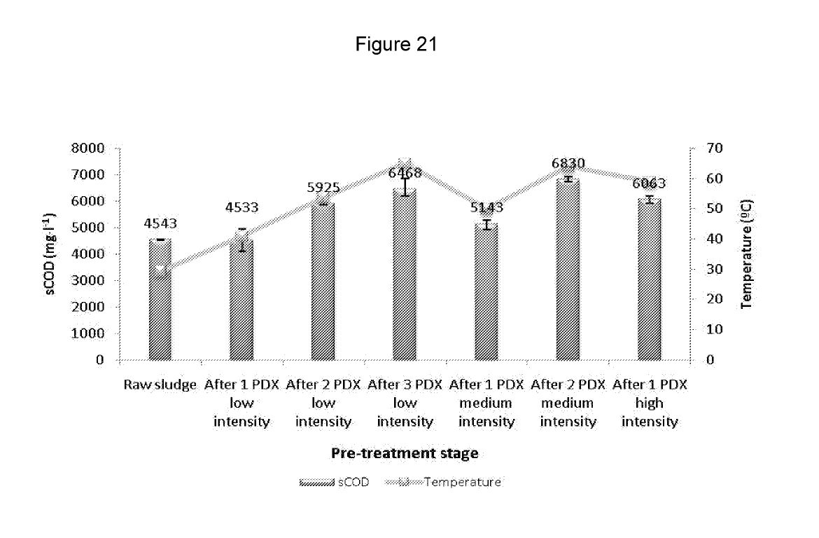

FIG. 22 shows sCOD comparison in unthickened WAS after different pre-treatments using the indicated devices (e.g., PDX reactors) operated at 8 bar. Low intensity (80-84 L·min⁻¹), medium intensity (60 L·min⁻¹), high intensity (36 L·min⁻¹). The given temperatures correspond to the final effluent.

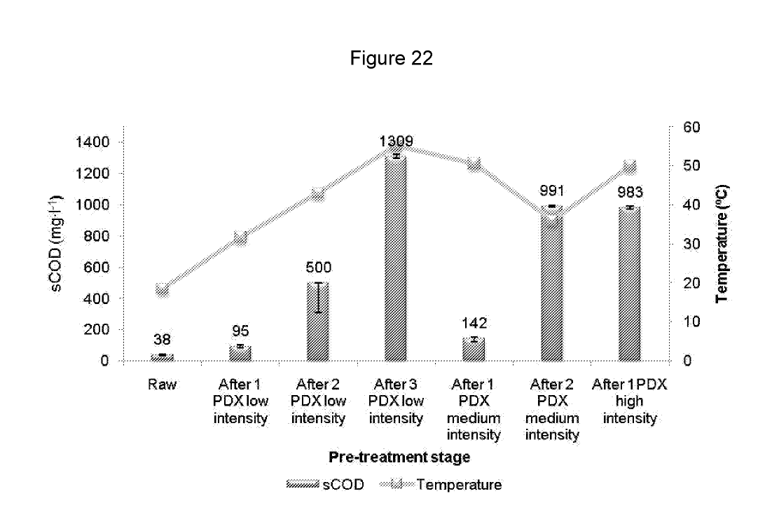

### DETAILED DESCRIPTION OF THE INVENTION

One embodiment of the present invention is a method of increasing soluble chemical oxygen demand (sCOD) in sewage sludge. This method comprises:
(i) passing the sewage sludge through one or more devices that comprise:
   (a) a hollow body provided with a straight-through passage of substantially constant cross-section, the passage having an inlet end and an outlet end for the entry and discharge, respectively, of the sewage sludge,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle, wherein the sCOD of the sewage sludge is increased by up to 3,000-4,000% after step (i) compared to the sCOD of the sewage sludge prior to step (i); and
(ii) passing the sewage sludge from step (i) through a digester.

Chemical oxygen demand (COD) is generally used as a measurement of the organic content of waste material related to the amount of oxygen required for the breakdown of these organic compounds. Soluble chemical oxygen demand (sCOD) refers to the COD of those matters that are dissolved in the waste material.

As used herein, “sewage sludge” means the residual, semi-solid material left from water-carried waste, such as, e.g., industrial waste water, excrement, surface runoffs from precipitation, other spent water from residences and institutions, carrying body wastes, washing water, food preparation wastes, laundry wastes, and other waste products of normal living. As used herein, “sewage sludge” includes primary sludge and waste activated sludge (WAS). As used herein, “waste activated sludge” or “WAS” means sewage sludge that has undergone a treatment process using organisms such as, e.g., bacteria and protozoans. “Primary sludge” means sewage sludge that has not undergone treatment.

In the present methods of the invention, the sewage sludge passes through one or more devices that break it down so that it is more easily processed by an anaerobic digester, an aerobic digester, or both. An exemplary device according to the present invention comprises (a) a hollow body provided with a straight-through passage of substantially constant cross-section, the passage having an inlet end and an outlet end for the entry and discharge respectively of the sewage sludge, (b) a transport fluid nozzle substantially circumscribing and opening into the passage intermediate the inlet and outlet ends thereof, (c) a transport fluid inlet communicating with the transport fluid nozzle for the introduction of a transport fluid, and (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle. As used herein, a convergent divergent nozzle means a nozzle that has a continuous and gradual reduction in cross-sectional area from the inlet to the throat, and a continuous and gradual increase in cross-sectional area from the throat to the outlet.

The passage of the device may be of any convenient cross-sectional shape suitable for the particular application of the device, e.g., pre-treatment of the sewage sludge. The passage shape may be circular, rectilinear or any intermediate shape, for example curvilinear.

The transport fluid maybe a fluid or a gas, such as e.g., water, air, nitrogen, helium, carbon dioxide, and steam. Preferably, the transport fluid is compressible. In another preferred embodiment, the transport fluid is steam or compressed air. The transport fluid may be introduced in either a continuous or discontinuous manner.

The intensity of the supersonic shock wave to generate the supersonic flow of the transport fluid is controllable by manipulating the various parameters prevailing within the system when operational. Accordingly, the flow rate, pressure and quality, i.e. in the case of steam the dryness, of the transport fluid may be regulated to obtain the required intensity of shockwave. In this connection, the intensity of the shockwave essentially relates to its degree of development within and across the passage and the mixing chamber. For example, the shockwave may develop across the whole section or may only partially do so providing a central core that is open. The intensity of the shockwave may therefore be variable. Furthermore the intensity of the shockwave may also be determined or defined by its position within or possibly without the passage or mixing chamber. The positioning of the shock wave may be manipulated in accordance with operator requirements and is not limited by the physical constraints of conventional ejectors, because the pseudo-vena contracta is of variable dimension.

The supersonic shockwave constitutes in one aspect of its function a barrier through or across which fluid flow occurs in one direction only and in that respect may be regarded as a one-way valve, there being no designed possibility of backflow through the shockwave. Further, the steam condensation immediately leading up to the creation of a supersonic shockwave provides a self-induction mechanism whereby the transport fluid is drawn in by the very shockwave the fluid produces and accordingly is to some extent self-perpetuating when in operation. It is predominantly the position and intensity of the shockwave, which dictates the pressure gradient obtained across the unit, which in turn defines the pressure and suction head and flow rate capabilities of the unit.

Preferably the transport fluid nozzle is located as close as possible to the projected surface of the sewage sludge or waste water stream, in practice and in this respect, a knife edge separation between the transport fluid or steam and the sewage sludge or waste water stream is of advantage in order to achieve the requisite degree of interaction. The angular orientation of the transport fluid nozzle with respect to the sewage sludge or waste water is of importance and may be shallow.

In some instances, a series of transport fluid nozzles may be provided lengthwise of the passage, and the geometry of the transport fluid nozzles may vary from one to the other dependent upon the effect desired. For example, the angular orientation may vary one to the other. The transport fluid nozzles may have differing geometries in order to afford different effects, i.e. different performance characteristics, with possibly differing parametric steam conditions. Each transport fluid nozzle will have a mixing chamber section downstream thereof. In the case where a series of transport fluid nozzles is provided, the number of operational transport fluid nozzles may be variable.

The transport fluid nozzle may be of a form to correspond with the shape of the passage. The invention optionally contemplates a full circumscription of the passage by the transport fluid nozzle irrespective of shape.

The transport fluid nozzle may be continuous or may be discontinuous in the form of a plurality of apertures, e.g. segmental, arranged in a circumscribing pattern that may be circular. In either case, each aperture may be provided with helical vanes formed in order to give in practice a swirl to the flow of the transport fluid. As a further alternative, the transport fluid nozzle may circumscribe the passage in the form of a continuous helical scroll over a length of the passage, the transport fluid nozzle aperture being formed in the wall of the passage.

The transport fluid nozzle is of a convergent-divergent geometry internally thereof, and in practice the transport fluid nozzle is configured to give the supersonic flow of transport fluid within the passage. For a given steam condition, i.e. dryness, pressure and temperature, the transport fluid nozzle is preferably configured to provide the highest velocity steam jet, the lowest pressure drop and the highest enthalpy.

For example only, and not by way of limitation, an optimum area ratio for the fluid transport nozzle, namely exit area:throat area, lies in the range 1.75 and 7.5, with an included angle of less than 9°.

The transport fluid nozzle is conveniently angled towards the flow, because this occasions penetration of the transport fluid and advantageously prevents both kinetic energy dissipation on the wall of the passage and premature condensation of the steam at the wall of the passage, where an adverse temperature differential prevails. The angular orientation of the transport fluid nozzle(s) is selected for optimum performance which is dependent, inter alia, on the transport fluid nozzle orientation and the internal geometry of the mixing chamber. Further, the angular orientation of each nozzle is selected to control the pseudo-convergent/divergent profile and the condensation shock wave position in accordance with the pressure and flow rates required from the device. Moreover, the creation of turbulence, governed, inter alia, by the angular orientation of the transport fluid nozzle, is important to achieve optimum performance by dispersal of the sewage sludge or waste water stream in order to increase acceleration by momentum transfer. This aspect is of particular import when the device is employed, optionally, as a pump. For example, and not by way of limitation, in the present invention it has been found that an angular orientation for each fluid transport nozzle may lie in the range 0 to 30°. Preferably, however, the all of the energy of the device(s) is directed toward treating the sewage sludge and the movement of the sewage sludge through the system is accomplished using conventional pumps, which are well known in the art.

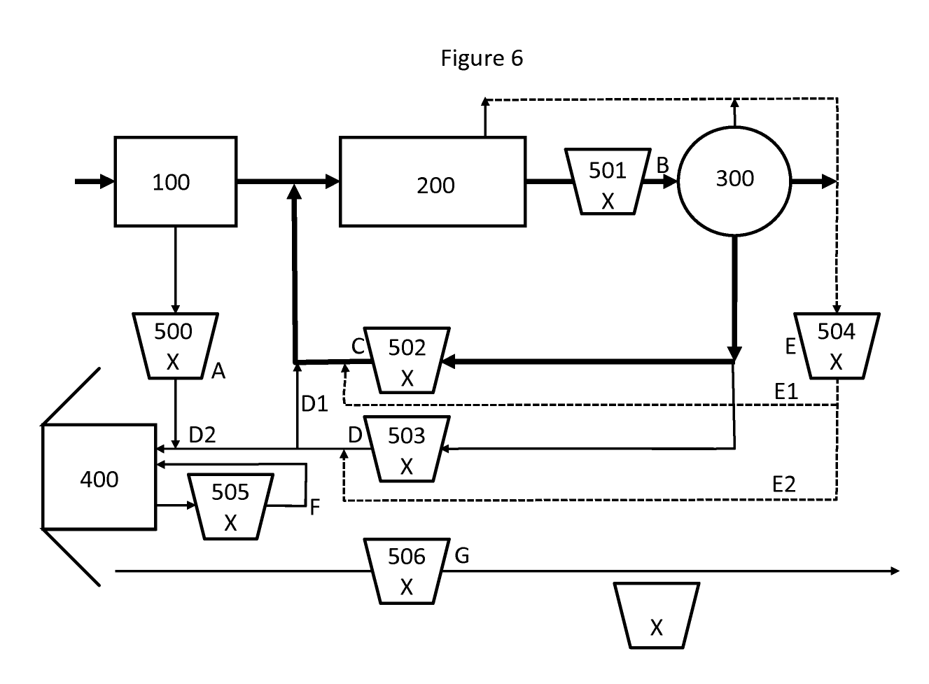

A series of fluid transport nozzles with respective mixing chamber sections associated therewith may be provided longitudinally of the passage and in this instance the transport fluid nozzles may have different angular orientations, for example decreasing from the first fluid transport nozzle in a downstream direction. Each nozzle may have a different function from the other or others, for example pumping, mixing, disintegrating, and may be selectively brought into operation in practice. See, e.g., FIG. 6. Each fluid transport nozzle may be configured to give the desired effects upon the sewage sludge or waste water stream. Further, in a multi-nozzle system by the introduction of the transport fluid, for example steam, phased heating may be achieved. This approach may be desirable to provide a gradual heating of the sewage sludge or waste water stream.

The mixing chamber geometry is determined by the desired and projected output performance and to match the designed steam conditions and nozzle geometry. In this respect it will be appreciated that there is a combinatory effect as between the various geometric features and their effect on performance, namely there is interaction between the various design and performance parameters having due regard to the defined function of the device.

At the location of each fluid transport nozzle in the passage, the dimension of the passage is greater than either upstream or downstream thereof because this increase compensates for the additional volume of fluid introduced. However, the cross sectional area of the mixing chamber is always consonant with or greater than the cross sectional area of the passage whereby any material entering the passage meets no constriction. The cross-sectional area of the mixing chamber may vary with length and may have differing degrees of reduction along its length, i.e. the mixing chamber may taper at different angles at different points along its length. The mixing chamber tapers from the location of each fluid transport nozzle and the taper ratio is selected such that the multi-phase flow velocity and pressure distribution of the condensation shock wave is maintained at its optimum position. This point is found in the region of the throat of the mixing chamber, but different positions, for example just after the throat, are also contemplated. As heretofore indicated, the intensity of the shockwave is controllable and coupled with its positioning will dictate its performance characteristics. The supersonic shockwave may not extend across the whole of the cross-sectional dimension of the passage or mixing chamber and may resemble an annulus. For example, it may be akin to a doughnut shape with a central relief. The regulation of the shockwave is a determinant of the performance of the device.

The mixing chamber of the present invention may be of variable length in order to provide a control on the point at which collapse or implosion of the steam, i.e. condensation and pressure drop, occurs, thus affecting the extent of the supersonic shock wave and the performance of the device. The length of the mixing chamber is thus chosen to provide the optimum performance regarding momentum transfer. In some expressions of the invention the length may be adjustable in situ rather than predesigned in order to provide a measure of versatility. The collapse of the steam gives rise to an implosive force which also influences the entrapped sewage sludge or waste water stream within the circumscribing steam stream to the extent that a pinching effect takes place. Accordingly, the steam collapse is focused, and the sewage sludge or waste water stream induced thereby is directionalized.

A cowl may be provided downstream of the outlet from the passage in order to enhance the collapse effect and to harness the pressure and to accelerate an additional volume of the sewage sludge or waste water stream.

In carrying out the method of the present invention the creation of a shock wave, plus control of its position and intensity, is occasioned by the design of the transport fluid nozzle interacting with the setting of the desired parametric conditions, for example in the case of steam as the transport fluid the pressure, the dryness or steam quality, the temperature and the flow rate to achieve the required performance of the steam nozzle. Representative devices according to the present invention are the PDX-13, -25, and -47 manufactured and sold by Pursuit Dynamics plc (Huntingdon U.K.). As set forth herein, these devices may be used alone, in series, and/or in parallel configurations.

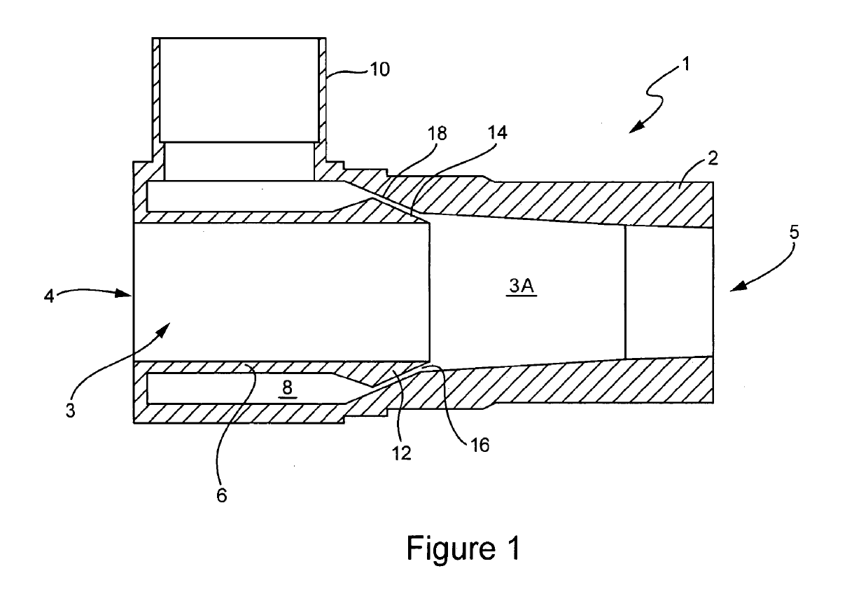

Turning now to the figures, FIG. 1 shows a representative device according to the present invention 1, comprising a housing 2 defining a passage 3 providing an inlet 4 and an outlet 5, the passage 3 being of substantially constant cross section. The inlet 4 is formed at the front end of a protrusion 6 extending into the housing 2 and defining exteriorly thereof a plenum 8 for the introduction of a transport fluid, the plenum 8 being provided with a transport fluid inlet 10. The protrusion 6 defines internally thereof part of the passage 3. The distal end 12 of the protrusion 6 remote from the inlet 4 is tapered on its relatively outer surface at 14 and defines an transport fluid nozzle 16 between it and a correspondingly tapered part 18 of the inner wall of the housing 2, the transport fluid nozzle 16 being in fluid communication with the plenum 8. The transport fluid nozzle 16 is so shaped as in use to give supersonic flow.

In operation, the inlet 4 is connected to a source of sewage sludge or waste water stream. Introduction of the transport fluid (steam, for example) into the device 1 through the inlet 10 and plenum 8 causes a jet of transport fluid to issue forth through the transport fluid nozzle 16. The parametric characteristics of the transport fluid are selected whereby in use a supersonic shock wave is generated within the passage 3 downstream of the transport fluid nozzle 16 in a section of the passage operating as a mixing chamber (3A). In operation, the shock wave is created in the mixing chamber (3A) and is maintained at an appropriate distance within mixing chamber (3A). The transport fluid jet issuing from the transport fluid nozzle occasions induction of the sewage sludge or waste water stream through the passage 3 which because of its constant dimension presents no obstacle to the flow. In the case steam is being used as the transport fluid, at some point determined by the steam and geometric conditions, and the rate of heat and mass transfer, the steam collapses or implodes and thus condenses causing a reduction in pressure. The steam condensation occurs immediately in front of the shockwave which is thus formed, which in turn creates a high pressure gradient which enhances the induction of fluid through the passage 3.

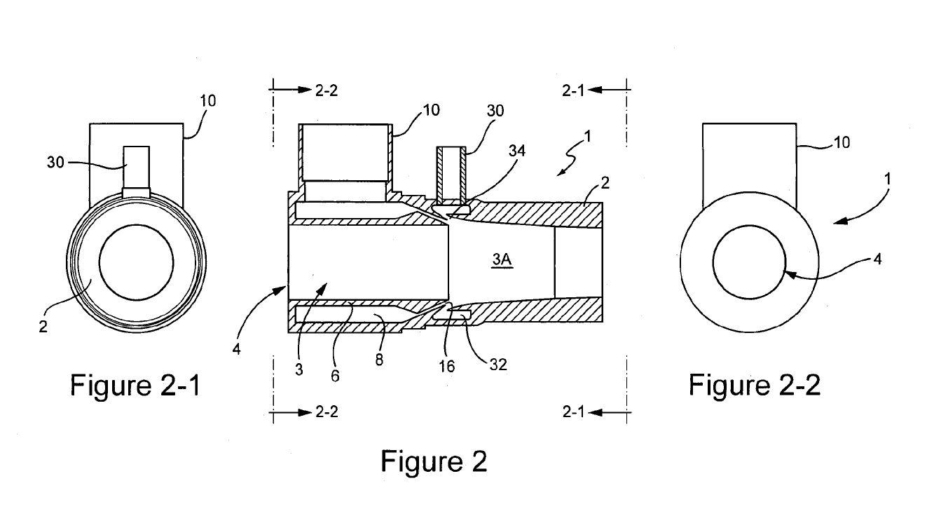

FIG. 2 shows another setup for the device according to the present invention similar to that illustrated in FIG. 1, except that an inlet 30 and plenum 32 are provided in the housing 2, together with a further annular nozzle 34 formed at a location coincident with that of the transport fluid nozzle 16. In this instance in use air is introduced to the transport fluid nozzle 34 from the inlet 30 and the plenum 32 and thence to the passage 3 to aerate the flow whereby a three-phase condition is realized constituted by the liquid phase of the body of water, the steam and the air.

The use of air or another gas, such as, e.g., nitrogen, may assist in the suppression of cavitation thus reducing physical deterioration of the housing when it occurs near the wall of the housing. In this connection the suppression of cavitation has the beneficial effect of reducing noise levels and accordingly the sonic signature of the device is thus diminished.

The performance of the device of the present invention may be complemented with the choice of materials from which it is constructed. Although the chosen materials have to be suitable for the temperature, steam pressure and working fluid, there are no other restrictions on choice.

The transport fluid nozzle 34 or another nozzle or nozzles may alternatively form the inlet for other fluids for use in mixing or treatment purposes. For example, a further air nozzle may be provided in the passage to provide aeration of the working fluid if necessary. The placement of the further nozzle may be either upstream or downstream of the transport fluid nozzle, or where more than one further nozzle is provided, the placement may be both upstream and downstream dependent upon requirements. In another aspect of the invention, the transport fluid nozzle 34 is used to introduce further sewage sludge or another fluid, for example water, in the event that the thermal capacity of the main working fluid flow may be insufficient to sustain the quenching of the steam to provide the requisite suction for the working fluid.

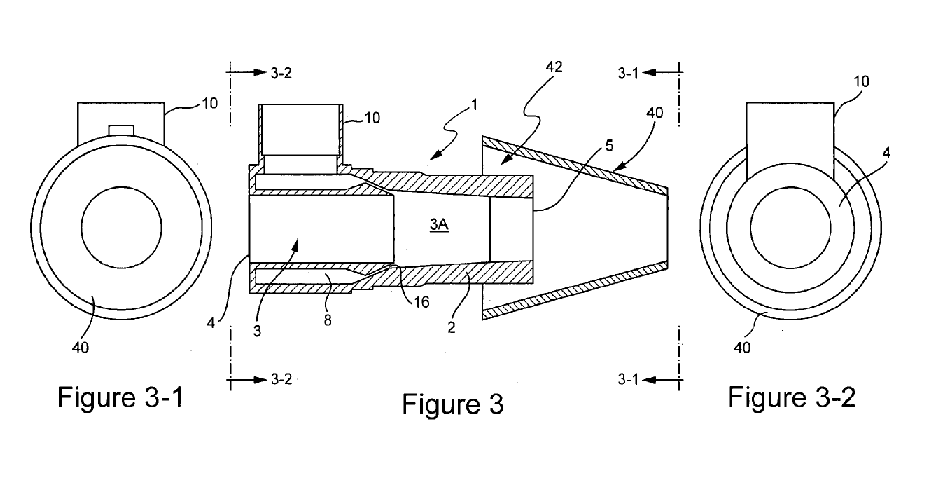

Referring now to FIG. 3, the device of FIG. 1 is provided with a frusto-conical cowl 40 adjacent the outlet 5 of the passage 3. Its disposition at this location allows a further concentration of the induction effect by virtue of the sewage sludge being drawn in not only through the inlet 4 but also through the annulus 42 formed between the outlet 5 and the internal wall of the cowl 40. A venturi effect is produced and thus affords a further acceleration of the flow through the combination of the housing and the cowl and thus the thrust is enhanced. The position of the cowl may be varied in order to give the desired effect.

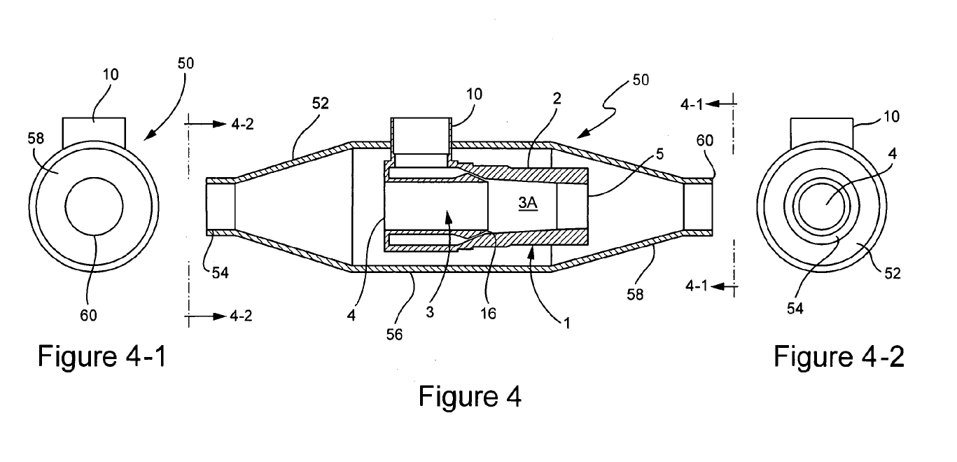

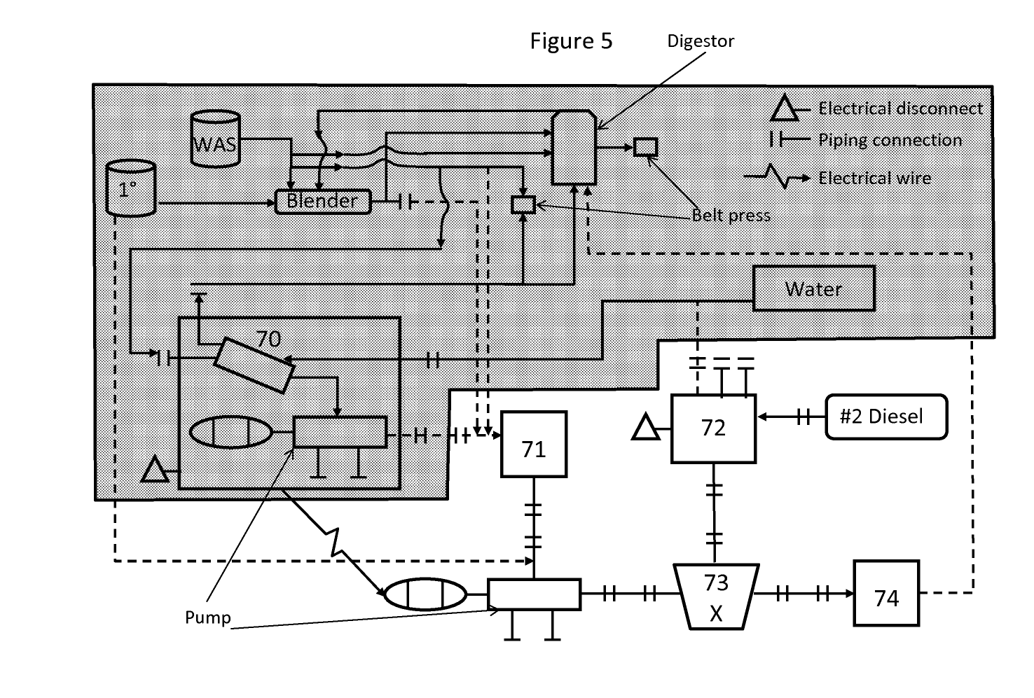

With reference to FIG. 4, the embodiment of FIG. 1 is disposed centrally within a casing 50 having a diverging inlet portion 52 having an inlet opening 54, a central portion 56 of constant cross section, leading to a converging outlet portion 58 having an outlet opening 60. In use, the inlet and outlet openings 54 and 60 are in fluid communication with a body of sewage sludge or waste water stream either therewithin or connected to a conduit. In operation the sewage sludge or waste water stream is drawn through the casing 50 with flow being induced around the housing 2 and also through the passage 3 of the device 1, which is of similar design to that shown in FIG. 1. The convergent portion 58 of the casing provides a means of enhancing the accelerative effect of the device and thus improves the thrust of the fluid flow. As an alternative to the specific configuration as shown in FIG. 4, the inlet portion 52 may display a shallower angle or indeed may be dimensionally coincident with the full bore 56. As shown in FIGS. 5 and 6, one or more of the devices may be integrated into a waste processing plant. Indeed, it is expected that the devices are designed and configured such that they can be retrofitted into currently existing anaerobic or aerobic waste treatment plants.

The grey box in FIG. 5 shows the general setup of an exemplary waste processing plant. In this scenario the WAS may be blended with primary sludge, with digested sludge, with both primary and digested sludge and fed to the digestor, or the WAS may be sent to a belt press to extract liquid. Furthermore, the WAS/WAS blends may be sent to a thickener 70 to thicken the material before it is sent to the belt press or to the digestor. The content of the digestor after digestion may also be sent to a belt press. The larger white area below the grey box in FIG. 5 shows an exemplary waste processing plant with the inclusion of one or more PDX reactors through which the sewage sludge is passed. The arrangement allows pure WAS, thickened WAS, pure primary sludge or a blend of WAS and primary sludge/WAS and digested sludge/WAS with both primary and digested sludge to be passed through the PDX reactor(s). When the sewage sludge is passed through a thickening module 70, sludge at various percent solids and viscosities may be obtained. Sludge, whether thickened or not is then held in the first holding tank 71. Subsequently, the sewage sludge is passed through one or more PDX reactors arranged in-line (PDX Module 73), followed by a settling tank 74. A boiler module 72, which may be fueled by #2 diesel, may be used to vary the temperature of the system. The content of the settling tank 74 may then be passed to the digestor for digestion or to a belt press in an aerobic process.

FIG. 6 shows a number of possible arrangements of devices, tanks, and digesters according to the present invention. For example, the sewage sludge may first pass through a primary settling tank 100 to a digester 400. Alternatively, the sewage sludge may pass through a primary settling tank 100 to an aeration tank 200, to a secondary settling tank 300 to the digester 400. The devices according to the present invention, such as, e.g., PDX reactors 500-506, may be arranged in any suitable configuration, particularly the configurations as shown.

The rate of the sewage sludge through the one or more of the devices may vary depending on the size and dimensions of the passage, the transport fluid nozzle, the mixing chamber, and the desired level of pre-treatment. The flow rate of the sewage sludge through the one or more devices may be less than about 86 L/minute, including about 15, 20, 25, 30, 35, 40, 45, 50, 55, 60, 65, 70, 75, 80, 85 L/minute. Preferably, the flow rate of the sewage sludge through the one or more devices is about 20-40 L/minute, such as about 40 L/minute. In another preferred embodiment, the flow rate of the sewage sludge through the one or more devices is about 50-80 L/min. Other exemplary flow rates of sewage sludge include 100 L/min, 200 L/min, 300 L/min, 400 L/min, 500 L/min, 600 L/min, 700 L/min, 800 L/min, 900 L/min, and 1000 L/min. A pump, preferably located upstream of the first PDX reactor, though it may be located downstream of the last PDX reactor may be utilized to provide the desired flow rate of the sludge. In some configurations one or more pumps located upstream, downstream or in-between the PDX reactors may be utilized.

The temperature rise of the sewage sludge across the one or more devices is between about 5-60° C., such as about 5° C., 10° C., 15° C., 20° C., 25° C., 30° C., 35° C., 40° C., 45° C., 50° C., 55° C., and 60° C. Preferably, the temperature of the sewage sludge after passing through the last of the one or more devices is between about 35° C.-100° C., such as between about 55° C. and 60° C. In another preferred embodiment, the temperature of the sewage sludge after passing through the last of the one or more devices is about 78° C.

In the present invention, the digester is a vessel in which the major portion of breakdown of the organic or biodegradable components of the sewage sludge takes place. The digester may be aerobic or anaerobic. Preferably, the digester is an anaerobic digester. As used herein, an “aerobic digester” means a digester that favors the breakdown of the organic or biodegradable components of the sewage sludge in the presence of oxygen. Carbon dioxide is produced as a result of aerobic digestion. As used herein, an “anaerobic digester” means a digester that favors the breakdown of the organic or biodegradable components of the sewage sludge in the absence of oxygen. Anaerobic digestion generates biogas with a high proportion of methane.

In the present invention, when an anaerobic digester is part of the method/system, the amount of increased methane production that may be achieved by integrating one or more of the devices will vary depending upon, e.g., the number of devices used and the kind of sewage sludge that is treated. Generally, an increase of at least about 30% in the methane production is achieved in a process/system using one or more of the devices compared to the same process/system run in the absence of such a device. Preferably, the increased methane production is about 30-70%, but may be higher. By way of example, when an anaerobic digester is used and the sewage sludge is primary sludge, the methods disclosed herein may generate an increase in methane production of about 70% compared to the same methods in the absence of the device(s). When an anaerobic digester is used and the sewage sludge is waste activated sludge, the methods disclosed herein may generate an increase in methane production of about 30% compared to the same methods in the absence of the device(s).

If the odor of the sludge is reduced sufficiently, and the level of pathogens in the sludge have also been reduced sufficiently, then the material may be converted to Class A sludge. As used herein, “Class A” sludge is as defined in 40 CFR §503.32 (2011). Class A sludge does not have to be land-filled, and is considered fertilizer.

The methods disclosed herein may further reduce odor-causing agents from the sewage sludge compared to the same methods in the absence of the device(s). Furthermore the methods disclosed herein may reduce the odor of the sewage sludge whether or not it has passed through a digestor, whether aerobic or anaerobic. Passing the sewage sludge through one or more reactors after it has been through a digestor (and possibly also before it has been through the digestor), whether aerobic or anaerobic, may further improve the odour of the sewage sludge. Deodorization has important implications. For example, if Class A sludge has a significant odor, customers will be reluctant/not allowed to use the sludge, and the waste treatment plant may have to dispose of the material via their existing transport contracts. Not wishing to be bound by a particular theory, it is believed that odor reduction may be attributed to the vaporization of various odor-causing agents within the sludge. In this regard, ammonia, for example, may be separated from the odor-causing agents. The separated ammonia may be vaporized, captured, and isolated from the sludge using conventional techniques and apparatus. For example, ammonia scrubbers, which allow ammonia to react with sulphuric acid react to form ammonium sulphate (widely used as a fertilizer), are commercially available from various manufacturers, such as, e.g., Advanced Air Technologies (Corunna, Mich.), Perma Pure LLC (Toms River, N.J.), and Envitech (San Diego, Calif.). Other removal technologies include the use of Liqui-Cel® Membrance Contactors (Charlotte, N.C.) and those disclosed in U.S. Pat. No. 4,198,292.

In one aspect of this embodiment, the dewaterability of the sewage sludge is increased by at least about 1%, including at least about 3% and at least about 5%, compared to a method in the absence of the device(s). Not wishing to be bound by a particular theory, it is believed that the improved dewaterability is caused by the increased destruction of polysaccharides through the use of the device(s).

In another aspect of this embodiment, the method further comprises passing the post-digester sewage sludge through at least one of the devices such as shown at positions F and G (reference numbers 505 and 506) of FIG. 6.

The number of devices used in any particular process or system according to the present invention will be determined by the desired degree of disintegration and with reference to maintaining the temperature of the sewage sludge or waste water stream below its boiling point, generally below 100° C. Thus, in one aspect of this embodiment, step (i) comprises passing the sewage sludge through one to four devices prior to step (ii). Preferably, step (i) comprises passing the sewage sludge through four devices prior to step (ii). In another aspect of this embodiment, each device is an in-line reactor.

Another embodiment of the present invention is a method of providing a waste water stream with a sCOD level that is increased by at least about 100% compared to a waste water stream in the absence of step (i) to an anaerobic digester. This method comprises:
(i) passing the waste water stream through one or more devices that comprise:
   (a) a hollow body provided with a straight-through passage of substantially constant cross-section, the passage having an inlet end and an outlet end for the entry and discharge respectively of the waste water,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water stream in the mixing chamber by the introduction of the transport fluid through the transport fluid nozzle, wherein the sCOD of the waste water stream is increased at least about 100% compared to a waste water stream in the absence of step (i); and
(ii) providing the waste water from step (i) to the anaerobic digester.

In this embodiment, “waste water stream” means unthickened waste activated sludge. Suitable devices and the operation of the devices are as set forth above.

Yet another embodiment of the present invention is a method of increasing methane production in an anaerobic waste water processing system. This method comprises:
(i) providing (a) a waste water processing plant comprising a primary settling tank, a secondary settling tank, and an anaerobic digester, each of which is directly or indirectly in fluid communication and (b) one or more devices disposed within the waste water processing plant;
(ii) passing the waste water through the one or more devices, each device comprising:
   (a) a hollow body provided with a straight-through passage of substantially constant cross-section, the passage having an inlet end and an outlet end for the entry and discharge respectively of the waste water,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water flow in the mixing chamber by the introduction of the transport fluid through the transport fluid nozzle, wherein organic material in the waste water is substantially disintegrated;
(iii) passing the waste water from step (ii) through the anaerobic digester; and
(iv) collecting methane produced in the anaerobic digester, wherein the amount of methane collected is at least 30% greater compared to a waste water processing plant without the devices.

As noted previously, the methods and systems of the present invention may be retrofitted into existing waste water processing plants or incorporated into newly built plants. While at a minimum, a waste water processing plant in accordance with the present invention includes a primary settling tank, a secondary settling tank and a digester, more than one settling tank and/or digester and/or other well known apparatus or other modules may be added to the waste water processing plant to accomplish other desired results. For example, aeration tanks, boiler modules, pumps, and various monitoring devices may be included in any of the methods and systems disclosed herein.

As used herein, a settling tank is a container the primary purpose of which is to allow the solids in the sludge to settle. An aeration tank is a container in which air is introduced into the sludge. Settling tanks and/or aeration tanks may be connected upstream or downstream from the devices.

Suitable devices, the operation of the devices, and the arrangement of devices in the waste water processing plant are as set forth above.

An additional embodiment of the present invention is a system for treating sewage sludge. This system comprises:
(i) a waste water processing plant comprising a primary settling tank, a secondary settling tank, and an anaerobic digester, each of which is directly or indirectly in fluid communication and four devices disposed within the waste water processing plant, each device comprising:
   (a) a hollow body provided with a straight-through passage of substantially constant cross-section, the passage having an inlet end and an outlet end for the entry and discharge respectively of the sewage sludge,
   (b) a transport fluid nozzle substantially circumscribing and opening into the passage intermediate the inlet and outlet ends thereof,
   (c) a transport fluid inlet communicating with the transport fluid nozzle for the introduction of a transport fluid, and
   (d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle,

wherein the devices increase the soluble chemical oxygen demand (sCOD) in the sewage sludge by up to 3,000-4,000% compared to a system in the absence of the device(s) prior to passing the sewage sludge to the digester.

Suitable devices, the operation of the devices, and the arrangement of devices in the waste water processing plant are as set forth above.

The following examples are provided to further illustrate the methods of the present invention. These examples are illustrative only and are not intended to limit the scope of the invention in any way.

### EXAMPLES

### Example 1

The experiments set forth below demonstrate that PDX reactors have the capability to provide higher COD in sewage sludge, and in combination with anaerobic digesters, pretreatment using PDX reactors of sewage sludge results in higher methane production. Furthermore, it was observed that PDX reactors inactivated live cells, and thus, in combination with aerobic/anaerobic digesters, Class A biosolids may be produced.

PDX-13 reactors were used to pre-treat Waste Activated Sludge (WAS), as well as combined primary and secondary sludges, to determine whether this setup increases COD in the existing WAS. In this setup, the increase in COD produced by PDX reactors was determined. The amount of methane produced per unit of COD was calculated using standard equations, and the value of using the PDX reactor to raise COD for additional methane production in anaerobic digesters was assigned. Furthermore, the amount of additional methane that may be produced by using PDX reactors were determined.

The experimental setup is shown in FIG. 5.

The results showed that sCOD can be improved by using one or more PDX reactors as a pre-treatment process for sewage sludges. The use of 1 PDX reactor resulted in sCOD increase of 286%, the use of 2 PDX reactors resulted in sCOD increase of 1294%, the use of 3 PDX reactors resulted in sCOD increase of 3060%, and the use of 4 PDX reactors results in sCOD increase of 4000%.

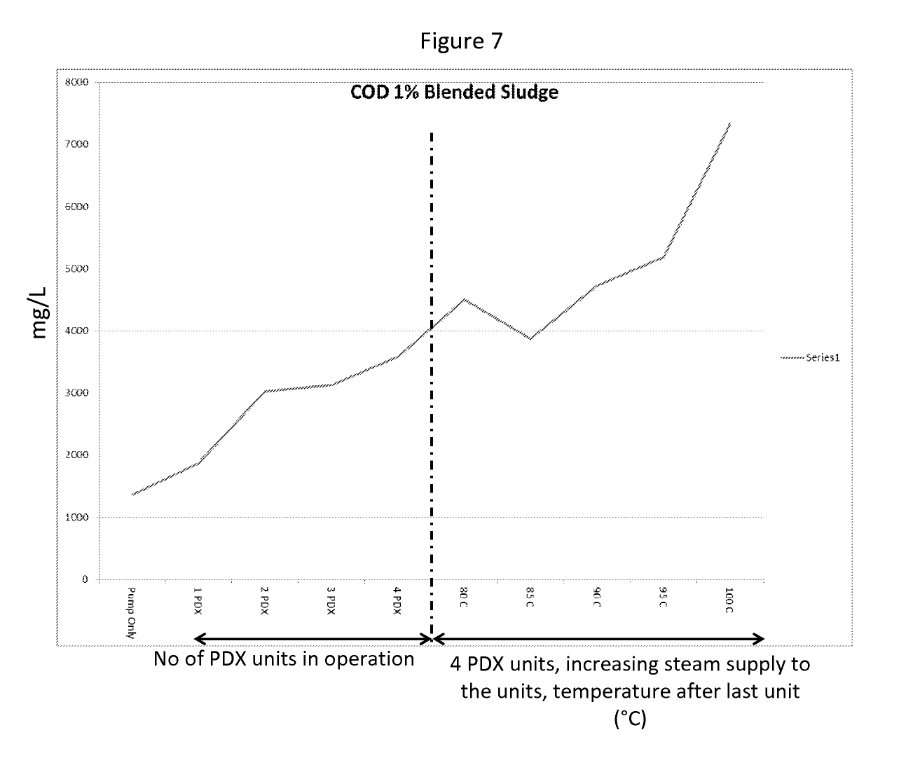

The results are further shown and explained in FIGS. 7-9. In these experiments, temperature of 100° C. was achieved in a steady state using high pressure steam (9.5 bars) at the flow rate of 40 L/min.

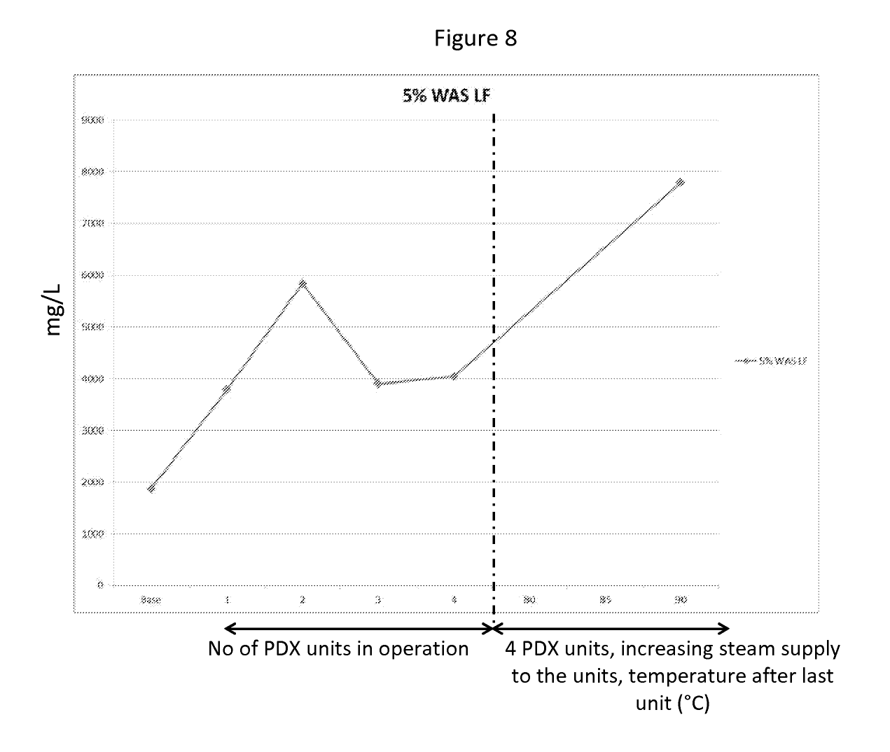

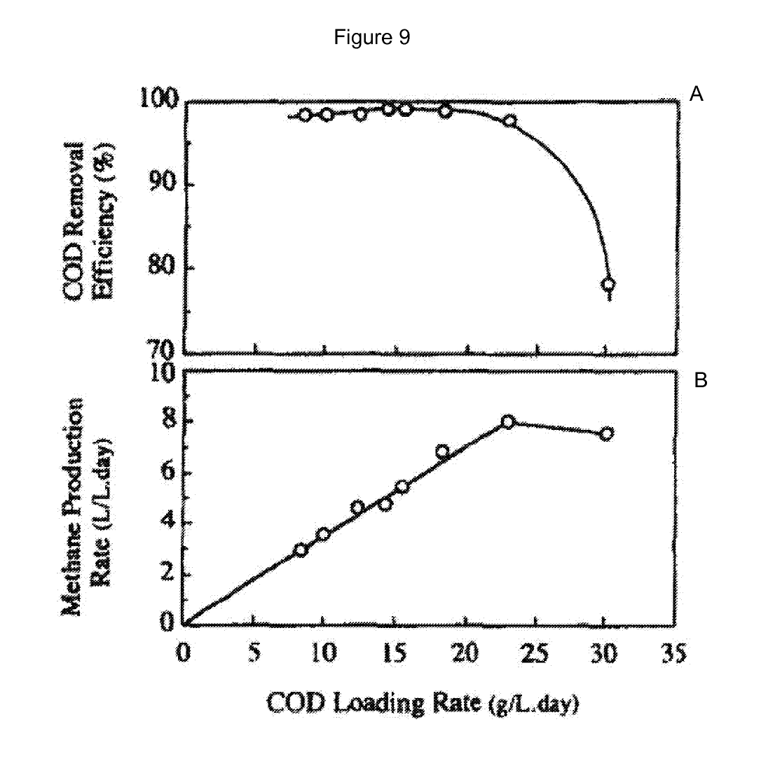

As shown in FIGS. 7 and 8, both an increase in the number of PDX reactors and an increase in temperature increases the COD in the sewage sludge. Furthermore, FIG. 9A (Fang et al, 1995) shows that for loading rates up to 23 g-COD/L day the COD removal efficiency could be 97-99%, which corresponds to 11,500 mg/L of COD in the wastewater. FIG. 9B (Fang et al, 1995) also shows that average methane production rate increases with an increase in COD loading rate, up to about 20 g/L·day.

The results clearly show that the use of PDX reactors in pre-treating sewage sludges increases the COD. Furthermore, it shows that sludges with a lower base COD may be used in the present invention. Additionally, the potential loading of the waste stream may be increased. Sludge fed to current digesters within the waste water industry is expected to have relatively low COD, unless waste streams that are high in organics are accessible. This means that there is significant potential for the devices of the present invention, e.g., PDX reactors, to allow waste water management facilities to increase their methane production.

It was additionally observed that PDX reactors inactivated cells, such as vegetative bacterial cells and other microbials. These results were confirmed by microscopy. It is expected that in connection with an aerobic or anaerobic digester, treated sewage sludges will meet EPA 503 regulations, and that Class A biosolids will be produced.

### Example 2

### Materials and Methods

Digested sludge, thickened WAS, and unthickened WAS were collected from a sewage treatment works (STW) which has a pre-treatment manufactured by Cambi (Asker, Norway) prior to the anaerobic digestion. The WAS used in the current testing was the plant's standard material and had not been CAMBI treated. This works serves 250,000 population equivalents (PE) and is located in the south east of England. The primary sludge used for the first set of experiments described below was collected from the STW at Cranfield University, which is a 3000 population equivalent (PE) trickling filter works. The primary sludge used for the digester trial was collected from the larger Cambi STW. All the sludges were collected early on the day of the trials to avoid any degradation associated with its storage and to operate with materials representative of a full scale STW.

A pilot-scale system used to mimic the operation of a pre-treatment loop in a full scale waste water treatment plant consisted of three PDX-13 reactors in series, each of them with an individual steam injector. The system was equipped with four thermometers (one at the entrance of each PDX reactor and one for the final effluent) which recorded the temperature profile. The system was scalable, so it could be operated with some of the PDX reactors off to assess the effect of the number of PDX reactors on sludge solubilization. The sludge was fed with a pump located upstream of the PDX reactors which could modify the flow rate to the pre-treatment unit between 36 to 84 L·min⁻¹.

The pilot-scale system was operated in two different stages. The first operational period was focused on determining the operational conditions under which a maximum sCOD release was obtained. During the second set of runs the pilot scale system was operated based on the optimized conditions to produce the sludges to be fed to the laboratory scale batch anaerobic digesters.

During the initial trial, the pre-treatment was applied to TWAS, primary sludge, digested sludge and WAS. Each of them was pre-treated in the pilot scale system using the operational conditions summarized in Table 1. Two different methods of altering the energy applied per unit of sludge treated were studied: (a) different number of PDX reactors in series (up to three) and (b) variable flow rates (low intensity=80-84 L·min⁻¹, medium intensity=60 L·min⁻¹ and high intensity=36-38 L·min⁻¹).

TABLE 1
Operational conditions during the two set or runs of the pre-treatment rig.

| Temperature (° C.) | | | | Steam pressure (bar) | | | | |
|---|---|---|---|---|---|---|---|---|
| | Exit 1 | Exit 2 | Exit 3 | 1 | 2 | 3 | Pump | Flow rate |
| Inlet | PDX | PDXs | PDXs | PDX | PDXs | PDXs | Hz | (L · min⁻¹) |

First set of runs

| | | | | | | | | | | |
|---|---|---|---|---|---|---|---|---|---|---|
| Thickened | 1 PDX | 16.5 | — | — | 31.0 | 8 | 8 | 8 | 30 | 80-84 |
| WAS | low | | | | | | | | | |
| | intensity | | | | | | | | | |
| | 2 PDXs | 16.5 | — | — | 42.0 | 8 | 8 | 8 | 30 | 80-84 |
| | low | | | | | | | | | |
| | intensity | | | | | | | | | |
| | 3 PDXs | 16.5 | — | — | 53.0 | 8 | 8 | 8 | 30 | 80-84 |
| | low | | | | | | | | | |
| | intensity | | | | | | | | | |
| Primary | 1 PDX | 17.1 | 32.1 | — | 32.0 | 8 | 8 | 8 | 29.4 | 80-84 |
| sludge | low | | | | | | | | | |
| | intensity | | | | | | | | | |
| | 2 PDXs | 17.1 | 30.4 | 43.2 | 43.2 | 8 | 8 | 8 | 29.4 | 80-84 |
| | low | | | | | | | | | |
| | intensity | | | | | | | | | |
| | 3 PDXs | 17.1 | 30.6 | 43.6 | 54.9 | 8 | 8 | 8 | 29.4 | 80-84 |
| | low | | | | | | | | | |
| | intensity | | | | | | | | | |
| | 1 PDX | 17.1 | 35.4 | — | 36.2 | 8 | 8 | 8 | 22.5 | 60 |
| | medium | | | | | | | | | |
| | intensity | | | | | | | | | |
| | 2 PDXs | 17.1 | 36.0 | 53.3 | 53.2 | 8 | 8 | 8 | 22.5 | 60 |
| | medium | | | | | | | | | |
| | intensity | | | | | | | | | |
| Digested | 1 PDX | 29.3 | — | — | 40.8 | 8 | 8 | 8 | 30 | 80-84 |
| sludge | low | | | | | | | | | |
| | intensity | | | | | | | | | |
| | 2 PDXs | 29.3 | — | — | 53.6 | 8 | 8 | 8 | 30 | 80-84 |
| | low | | | | | | | | | |
| | intensity | | | | | | | | | |
| | 3 PDXs | 29.3 | — | — | 65.0 | 8 | 8 | 8 | 30 | 80-84 |
| | low | | | | | | | | | |
| | intensity | | | | | | | | | |
| | 1 PDX | 29.3 | — | — | 50.0 | 8 | 8 | 8 | 22 | 60 |
| | medium | | | | | | | | | |
| | intensity | | | | | | | | | |
| | 2 PDXs | 29.3 | — | — | 64.0 | 8 | 8 | 8 | 22 | 60 |
| | medium | | | | | | | | | |
| | intensity | | | | | | | | | |
| | 1 PDX | 29.3 | — | — | 58.9 | 8 | 8 | 8 | 15 | 38 |
| | high | | | | | | | | | |
| | intensity | | | | | | | | | |
| Unthickened | 1 PDX | 18.5 | — | — | 31.7 | 8 | 8 | 8 | 29 | 80-84 |
| WAS | low | | | | | | | | | |
| | intensity | | | | | | | | | |
| | 2 PDXs | 18.5 | — | 41.1 | 43.0 | 8 | 8 | 8 | 29 | 80-84 |
| | low | | | | | | | | | |
| | intensity | | | | | | | | | |
| | 3 PDXs | 18.5 | — | 41.6 | 55.1 | 8 | 8 | 8 | 29 | 80-84 |
| | low | | | | | | | | | |
| | intensity | | | | | | | | | |
| | 1 PDX | 18.5 | — | 48.8 | 50.6 | 8 | 8 | 8 | 25 | 60 |
| | medium | | | | | | | | | |
| | intensity | | | | | | | | | |
| | 2 PDXs | 18.5 | — | — | 36.0 | 8 | 8 | 8 | 25 | 60 |
| | medium | | | | | | | | | |
| | intensity | | | | | | | | | |
| | 1 PDX | 18.5 | — | — | 50.0 | 8 | 8 | 8 | 14 | 36 |
| | high | | | | | | | | | |
| | intensity | | | | | | | | | |

Second set of runs

| | | | | | | | | | |
|---|---|---|---|---|---|---|---|---|---|
| Thickened WAS | 18.2 | 31.2 | 45 | 58.1 | 8 | 8 | 7.5 | 30 | 80-84 |
| 3 PDXs low | | | | | | | | | |
| intensity | | | | | | | | | |
| Thickened WAS | 18.3 | 38.1 | 56.9 | — | 8 | 8 | — | 22 | 60 |
| 2 PDXs medium | | | | | | | | | |
| intensity | | | | | | | | | |
| Digested sludge | 32.4 | 54.7 | 67.7 | 81.5 | 8 | 8 | 8 | 30 | 80-84 |
| 3 PDXs low | | | | | | | | | |
| intensity | | | | | | | | | |

Methane potential tests were conducted using laboratory scale batch anaerobic digesters. The reactors consisted of one litre glass bottles (Fisher Scientific, Loughborough, England) sealed with rubber stoppers. The mesophilic and anaerobic conditions were ensured by placing all the digesters in a temperature controlled water bath (38.5° C.) and by bubbling pure nitrogen at the beginning of the digestion, respectively. The gas was collected and measured daily through the water displacement method.

Ten digesters were set up, each of them with a total sludge volume of 500 ml. Five of the reactors received pre-treated material (test digesters) while the rest received un-pre-treated sludge (control digesters), as outlined in Table 2. All the bottles were inoculated with digested sludge from the Cambi 250,000 PE STW.

TABLE 2
Content of the laboratory scale batch anaerobic digesters and number
of replicates. All the percentages are given by weight. All the
pre-treatments refer to a 3 PDX Reactor low intensity process.

| | Content | Replicates |
|---|---|---|
| test WAS | 20% inoculum + 80% pre-treated TWAS | 2 |
| control WAS | 20% inoculum + 80% un-pre-treated | 2 |
| | TWAS | |
| test WAS + | 20% inoculum + 80% mix of sludges | 2 |
| primary | (40% pre-treated TWAS + 60% un- | |
| | pre-treated primary sludge) | |
| control WAS + | 20% inoculum + 80% mix of sludges | 2 |
| primary | (40% un-pre-treated TWAS + 60% un- | |
| | pre-treated primary sludge) | |
| test digested | 20% inoculum + 80% pre-treated | 1 |
| | digested sludge | |
| control digested | 100% inoculum | 1 |

Both the raw and pre-treated sludges where analyzed on the same day of the trials for sCOD, total solids (TS) and volatile solids (VS) to ensure the representativeness of the analysis. The particle size distribution was obtained either the day of the trials or the following one. For the rest of the analysis, the solid free fraction of the sludges was frozen to preserve the samples. In the samples for VFA analysis 10 μl of H₂SO₄ was added before freezing to avoid acid degradation when stored.

The concentration of TS and VS was quantified according to standard methods 2540B and 2540E, respectively (APHA, 2005). The solid free fraction of the sludges was required to quantify the sCOD. The samples were centrifuged at 7548×g and 20° C. for 20 minutes in a Sorvall Lengend RT centrifuge (Thermo Fisher Scientific, Basingstoke, England). The supernatant was vacuum filtered through 0.7 μm pore size glass microfiber filters GF/C (Whatman™, Kent, England) and filtered with 0.45 μm pore size Syringe-drive Filter Units (Millipore™, Billerica, United States).

The sCOD was determined by using Merck Spectroquant test cells with the NOVA 60 photometer (Merck Chemicals Ltd, Beeston, England). The alkalinity was determined by titration with HCl 0.02M, according to the standard method 2320B (APHA, 2005).

The DD achieved by the PDX reactor pre-treatment was calculated according to equation 1:

$$DD ( \% ) = \frac{{sCOD}_{1} - {sCOD}_{2}}{{sCOD}_{3} - {sCOD}_{2}} - 100 \qquad 1$$

### Where:

sCOD₁=sCOD of the pre-treated sludge (mg·l⁻¹)

sCOD₂=sCOD of the untreated sludge (mg·l⁻¹)

sCOD₃=sCOD of the sludge hydrolysed with NaOH (mg·l⁻¹)

The maximum sCOD of the sample (sCOD₃) was determined by alkaline hydrolysis, which consists of the digestion of a mix 1:1 of sludge and 0.5M NaOH solution at 20° C. during 22 hours. After the digestion period, the solid free fraction of the solution was prepared to determine its sCOD. This alkaline hydrolysis method has been widely applied (Abelleira et al., 2011; Khanal et al., 2007; Müller, 2000).

The methane concentration in the biogas was measured by taking a sample of the head-space of the digesters and analyzing it in a 1440D SERVOPRO gas analyzer (Servomex, Crowborough, England). Both the biogas production and methane concentration where measured up to twice a day. The digester content was agitated prior to each sample collection.

The digestates dewaterability was assessed with the capillary suction time (CST) test described in Standard Method 2710G (APHA, 2005), using the CST model 200 (Triton Electronics Ltd., Great Dunmow, England).

### Results

The pilot scale system was operated twice. The first set of runs aimed to determine the effect of the number of PDX reactors and its operational conditions for the solubilization of different sludges (thickened WAS, primary sludge, digested sludge and unthickened WAS). The obtained results determined the operational conditions for the second set of runs, which produced the feed to the laboratory scale batch anaerobic digesters.

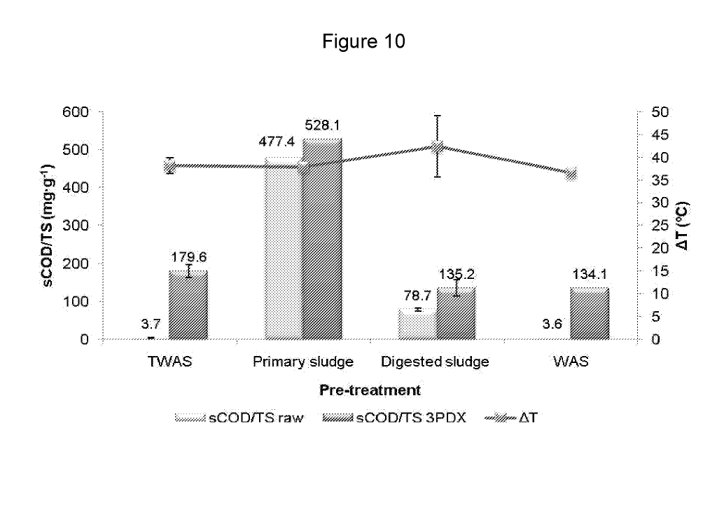

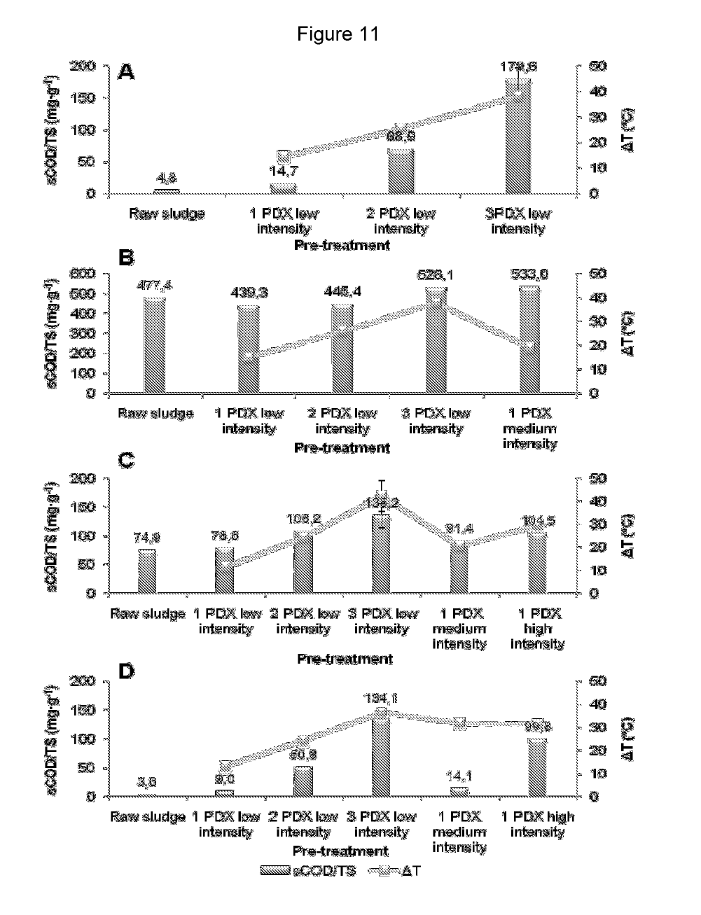

The effect of operating 3 PDX reactors in series on different sludge types is shown in FIG. 10. The pre-treatment with PDX reactors was operated at 8 bar and with a low energy intensity (80-84 L·min⁻¹). It was observed that the maximum sCOD normalized with respect to the total solid content of the sludge was obtained with the primary sludge. However, this is due to the low solids content (0.1% dry solids (DS)) of the sludge rather than to the solubilization of organic material associated with the pre-treatment (FIG. 11B). Besides, the primary sludge presented a lower improvement when comparing the pre-treated and un-pre-treated material (11%). It was the TWAS, which increased the sCOD/TS more after pre-treatment (4754%).

If the absolute values are considered, the highest sCOD was achieved in the TWAS followed by the digested sludge (8711 and 7582 mg·L⁻¹ respectively, which was the average of two runs each). As for the sCOD percentage increase when compared with the raw sludge, the pre-treatment achieved its best performance with the TWAS (4367%).

As outlined in FIG. 11, TWAS, WAS and digested sludge behaved in a similar manner, with an increasing normalized sCOD when the energy applied to the sludge was raised. The sCOD/TS of the digested sludge was multiplied between 1.3 to 1.4 times per PDX reactor, while values between 2.5 to 5.6 and 2.6 to 4.7 where obtained with WAS and TWAS, respectively. This trend was not followed by the primary sludge, whose organic material content remained almost unchanged with all the operational conditions tried (FIG. 11B).

The increase of temperature associated per PDX reactor in series was similar for all four sludges. For example, the effluent temperature of a 3 PDX reactor flowsheet was 1.5-1.7 times that of the 2 PDX reactor pre-treatment effluent temperature which in turn was 1.8-2.1 times that of the single PDX reactor effluent temperature.

The effect of increasing the energy applied to each sludge by reducing the flow rate rather than by increasing the number of PDX reactors is also outlined in FIG. 11. None of the sludges tested showed a significant increase in terms of sCOD/TS when decreasing the sludge flow rate from 84-80 L·min⁻¹ to 60 L·min⁻¹ using a single PDX reactor. Only the unthickened WAS sludge increased the sCOD/TS release significantly under high energy intensities.

During the pre-treatment trials using the pilot scale system, two ways of increasing the energy applied per litre of sludge treated were studied: (1) increase the number of PDX reactors and (2) reduce sludge flow rate. The previous section studied individually the benefit of these alternatives, while this section aimed to compare which combination achieves a higher biodegradability of the sludge with the lowest energy consumption. For this purpose the sCOD/TS release from two PDX reactors operated at a low intensity pre-treatment was compared with a single PDX reactor operated at a medium intensity, and three PDX reactors operated at a low intensity were compared with two PDX reactors operated at a medium intensity (Table 3).

TABLE 3
Comparison between the normalised sCOD achieved by increasing
the number of PDX reactors and increasing the energy intensity
(reduced flow rate) for different sludges and the associated
increase in temperature with respect to the input sludge.

| | | | |
|---|---|---|---|
| | 1 PDX | | 2 PDX(s) |
| 2 PDX(s) | medium | 3 PDX(s) | medium |
| low intensity | intensity | low intensity | intensity |

TWAS

| | | | | |
|---|---|---|---|---|
| sCOD/TS | N/A | N/A | 179.6 * | 174.5 |
| (mg · g⁻¹) | | | | |
| ΔT (° C.) | N/A | N/A | 38.2 * | 38.6 |

Primary sludge

| | | | | |
|---|---|---|---|---|
| sCOD/TS | 445.4 | 533.0 | 528.1 | 618.7 |
| (mg · g⁻¹) | | | | |
| ΔT (° C.) | 26.1 | 19.1 | 37.8 | 36.1 |

Digested sludge

| | | | | |
|---|---|---|---|---|
| sCOD/TS | 108.2 | 91.4 | 135.2 * | 117.9 |
| (mg · g⁻¹) | | | | |
| ΔT (° C.) | 24.3 | 20.7 | 42.4 * | 34.7 |

WAS

| | | | | |
|---|---|---|---|---|
| sCOD/TS | 50.8 | 14.1 | 134.1 | 99.3 |
| (mg · g⁻¹) | | | | |
| ΔT (° C.) | 24.5 | 32.1 | 36.6 | 17.5 |

Key: N/A = not available
* = values average of two runs

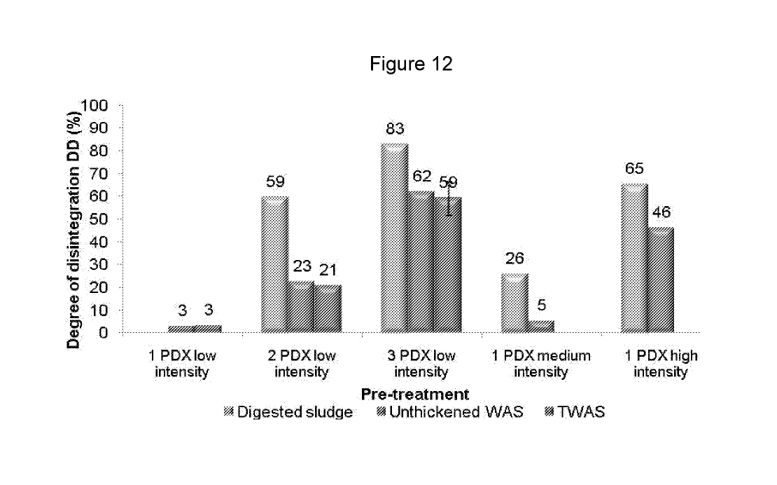

Both the digested sludge and the unthickened WAS achieved a higher normalized sCOD when additional PDX reactors were added to the flowsheet rather than when the flow rate was decreased. The difference was not significant for the TWAS and the primary sludge showed the opposite behavior. However, it has to be taken into account that the absolute sCOD of the primary sludge did not change significantly with any of the pre-treatments, so the increase in sCOD/TS observed may be associated with the inaccuracy of handling a sludge of 0.1% DS rather than with the pre-treatment itself. The positive effect on solubilization of additional PDX reactors was further emphasized when the degree of disintegration data was examined (FIG. 12). The degree of disintegration achieved was considerably higher when an additional PDX reactor was added to the flowsheet rather than when the applied intensity was increased by decreasing the flow rate (FIG. 12). A clear example was found with the WAS, for which the DD obtained with a 2 PDX reactor set for a low intensity pre-treatment was 7.7 times that associated with 1 PDX reactor at low intensity. However, the DD remained almost unchanged when the WAS was treated with 1 PDX reactor at medium intensity (60 L·min⁻¹).

The pre-treated material was assessed in relation to its digestibility and methane potential in ten batch anaerobic digesters. The characteristics of the pre-treated sludges and results obtained are outlined in Tables 4 and 5.

TABLE 4
Characterisation of the sludges used for the preparation
of the mixes fed to the batch anaerobic digesters.

| | Primary | TWAS | | Digested sludge | |
|---|---|---|---|---|---|
| | sludge | | 3 PDXs low | raw | 3 PDXs low |
| | raw | raw | intensity | (inoculum) | intensity |
| sCOD (mg · l⁻¹) | 9324 ± 259 | 139 ± 20 | 9740 ± 160 | 4813 ± 98 | 8696 ± 104 |
| TS (g · l⁻¹) | 90.8 ± 2.1 | 53.6 ± 0.7 | 49.4 ± 0.9 | 58.4 ± 0.1 | 55.5 ± 0.9 |
| VS (g · l⁻¹) | 71.1 ± 2.0 | 26.2 ± 0.5 | 35.1 ± 0.32 | 37.2 ± 0.1 | 35.3 ± 0.4 |
| sCOD/TS (mg · g⁻¹) | 102.6 | 2.6 | 197.0 | 82.5 | 156.8 |
| Ammonia (mg NH₄₋ N · l⁻¹) | N/A | 13.3 ± 0.3 | 16.8 ± 3.1 | 1956.7 ± 33.3 | 1890.0 ± 20.0 |

TABLE 5
Feed sludge and digestate characteristics, operational conditions, batch anaerobic digestion performance
and removal efficiencies. The daily based data have been averaged only for the best operational period.

| | | | | | |
|---|---|---|---|---|---|
| | | test WAS + | control WAS + | test | control |
| test WAS | control WAS | primary | primary | digested | digested |

Feed

| | | | | | | |
|---|---|---|---|---|---|---|
| sCOD | 9153 ± 83 | 3578 ± 93 | 8728 ± 133 | 6285 ± 115 | 6979 ± 121 | 4813 ± 98 |
| (mg · l⁻¹) | | | | | | |
| TS | 52.3 ± 0.6 | 57.5 ± 0.7 | 71.1 ± 0.3 | 73.8 ± 1.1 | 56.5 ± 0.1 | 58.4 ± 0.1 |
| (g · l⁻¹) | | | | | | |
| VS | 33.0 ± 4.8 | 37.3 ± 3.9 | 52.4 ± 0.2 | 54.7 ± 1.1 | 35.8 ± 0.4 | 37.2 ± 0.1 |
| (g · l⁻¹) | | | | | | |
| sCOD/TS | 175.0 | 62.2 | 122.7 | 85.2 | 123.6 | 82.5 |
| (mg · g⁻¹) | | | | | | |
| sCOD/VS | 277.1 | 95.8 | 166.7 | 114.8 | 194.8 | 129.4 |
| (mg · g⁻¹) | | | | | | |
| TVFA | 13018.8 | 2133.7 | 4813.2 | 3010.2 | 3773.7 | 3457.2 |
| (mg · l⁻¹) | | | | | | |
| Ammonia | 560.0 ± 0.0 | 466.7 ± 6.7 | 756.7 ± 6.7 | 633.3 ± 13.3 | N/A | 1956.7 ± 16.7 |
| (mg | | | | | | |
| NH₄—N · | | | | | | |
| l⁻¹) | | | | | | |

Operational conditions

| | | | | | | |
|---|---|---|---|---|---|---|
| T (° C.) | 38.0 | 38.0 | 38.0 | 38.0 | 38.0 | 38.0 |
| SRT (d) | 40 | 40 | 40 | 40 | 40 | 40 |
| Type | batch | batch | batch | Batch | batch | batch |

Biogas

| | | | | | | |
|---|---|---|---|---|---|---|
| CH₄ daily | 3.2E−05 ± 4.4E−06 | 2.0E−05 ± 2.9E−06 | 1.3E−04 ± 1.1E−05 | 9.4E−05 ± 8.0E−06 | 6.5E−06 | 9.8E−06 |
| production | | | | | | |
| (m³ · d⁻¹) | | | | | | |
| Normalized CH₄ | 1.6E−03 ± 2.2E−04 | 9.6E−04 ± 1.3E−04 | 4.9E−03 ± 2.7E−04 | 3.5E−03 ± 4.2E−04 | 3.4E−04 | 4.0E−04 |
| daily production | | | | | | |
| (m³ CH⁴ · (kg | | | | | | |
| VS_{fed} · d)⁻¹) | | | | | | |
| Normalized | 1.5E−01 ± 2.9E−02 | 2.1E−01 ± 7.4E−03 | 1.6E−01 ± 1.3E−02 | 1.9E−01 ± 2.7E−03 | 5.0E−02 | 4.6E−02 |
| cumulative | | | | | | |
| biogas (m³ · kg | | | | | | |
| VS⁻¹_{fed}) | | | | | | |
| Biogas yield | 0.30 ± 5.7E−02 | 0.54 ± 2.3E−02 | 0.39 ± 7.8E−02 | 0.41 ± 1.5E−02 | 0.21 | 0.15 |
| (m³ · kg | | | | | | |
| VS⁻¹_{removed}) | | | | | | |
| Methane content (%) | 68.1 ± 4.8 | 64.7 ± 5.2 | 80.8 ± 2.4 | 77.8 ± 1.3 | 56.4 | 55.0 |

Digestate

| | | | | | | |
|---|---|---|---|---|---|---|
| sCOD | 2503 ± 64 | 2337 ± 287 | 10255 ± 335 | 7300 ± 1642 | 3833 | 4193 |
| (mg · l⁻¹) | | | | | | |
| TS | 34.6 ± 0.23 | 39.4 ± 0.4 | 51.3 ± 1.3 | 51.2 ± 0.8 | 48.2 | 54 |
| (g · l⁻¹) | | | | | | |
| VS | 18.0 ± 0.1 | 23.3 ± 0.2 | 31.1 ± 3.3 | 31.0 ± 0.9 | 27.9 | 31.8 |
| (g · l⁻¹) | | | | | | |
| sCOD/TS | 72.3 ± 2.3 | 59.3 ± 6.6 | 200.1 ± 1.5 | 143.2 ± 34.3 | 79.5 | 77.7 |
| (mg · g⁻¹) | | | | | | |
| sCOD/VS | 139.1 ± 4.3 | 100.0 ± 11.5 | 332.6 ± 24.1 | 234.3 ± 46.4 | 137.3 | 131.8 |
| (mg · g⁻¹) | | | | | | |
| TVFA | 58.1 ± 8.8 | 35.9 ± 35.9 | 374.8 ± 136.8 | 369.9 ± 272.8 | 510.7 | 634.9 |
| (mg · L⁻¹) | | | | | | |
| VFA | 44.9 ± 4.3 | 16.8 ± 16.8 | 16.3 ± 16.3 | 104.8 ± 61.5 | 73.8 | 279.9 |
| (mg acetic | | | | | | |
| acid · l⁻¹) | | | | | | |
| CST (s) | 1561.0 ± 71.2 | 1542.3 ± 93.0 | 1099.9 ± 15.7 | 1993.6 ± 147.4 | 1074.3 | 1105.1 |

Removal efficiencies

| | | | | | | |
|---|---|---|---|---|---|---|
| VS (%) | 45.5 ± 0.3 | 37.5 ± 0.5 | 40.7 ± 6.2 | 43.4 ± 1.6 | 22 | 14.5 |
| TS (%) | 33.8 ± 0.4 | 31.6 ± 0.7 | 27.9 ± 1.8 | 30.7 ± 1.1 | 14.6 | 7.6 |
| sCOD (%) | 72.7 ± 0.7 | 34.7 ± 8.0 | −17.5 ± 3.8 | −16.1 ± 26.1 | 45.1 | 12.9 |
| sCOD/TS (%) | 58.7 ± 1.3 | 4.7 ± 10.7 | 63.0 ± 1.2 | 68.2 ± 40.3 | 35.7 | 5.7 |

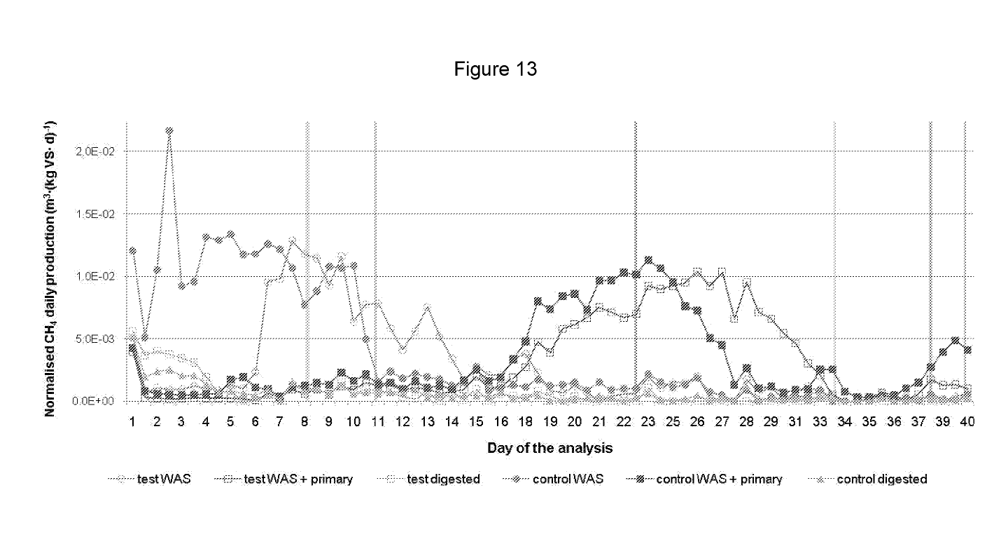

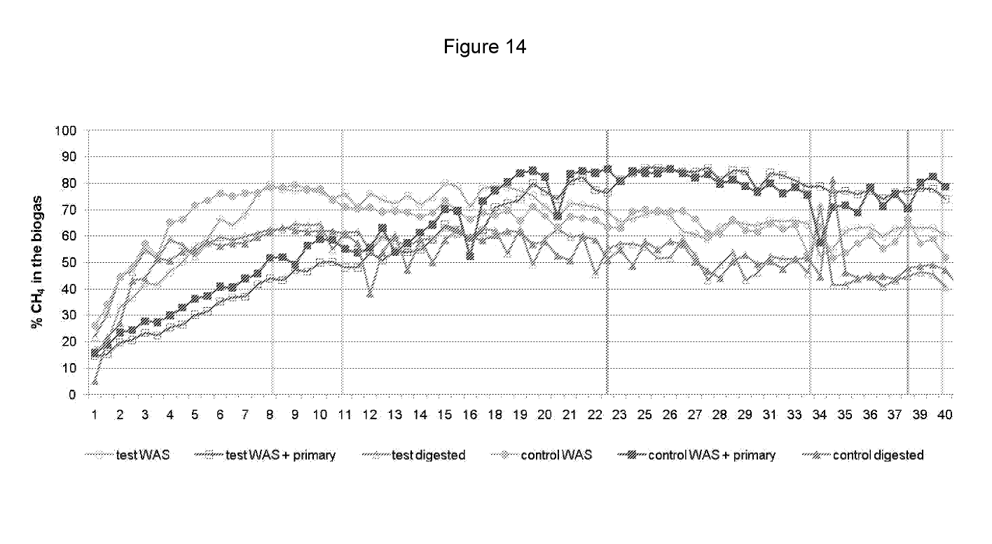

FIGS. 13 and 14 show results of the laboratory scale batch anaerobic digesters. In terms of the percentage of methane in the biogas, the tests required an acclimation period to reach higher contents than the controls. Thus, the analysis of the results has been done considering only the stable operational period of each digester: days 11 to 40 for test WAS and control WAS, days 23 to 38 for test WAS+primary and control WAS+primary and days 8 to 33 for test digested and control digested. The operational period considered for the cumulative parameters was 40 days, because after this any sudden increase in the daily biogas production was attributed to the endogenous respiration of the sludges.

During the stable operational periods, the tests produced biogas with higher methane content than the controls (Table 5) and showed an increased daily methane production, both absolute and normalized, with respect to the VS fed. The best performance was obtained for the test WAS over the control WAS with an average increase of the methane content in the biogas of 5% and a 71% higher daily methane production normalized to the initial VS. Table 6 shows a summary of these percentages of improvement.

TABLE 6
Methane content in the biogas and normalised daily methane production over the stable
period of the digesters and percentage improvement referred to the control.

| | | | Normalized daily | Improvement in |
|---|---|---|---|---|
| | | Improvement in | CH₄ production m³ | normalized daily |
| | CH₄ in biogas(%) | CH₄ content (%) | CH · (kg VS_{fed} · d)⁻¹ | CH₄ production(%) |
| test WAS | 68.1 ± 4.8 | 5 | 1.6E−03 ± 2.2E−04 | 71 |
| test WAS + | 80.8 ± 2.4 | 4 | 4.9E−03 ± 2.7E−04 | 41 |
| primary | | | | |
| test digested | 56.4 | 3 | 2.79E−03 | 29 |
| control WAS | 64.7 ± 5.1 | N/A | 9.6E−04 ± 1.3E−04 | N/A |
| control WAS + | 77.8 ± 1.3 | N/A | 3.5E−03 ± 4.2E−04 | N/A |
| primary | | | | |
| control digested | 55.0 | N/A | 1.96E−03 | N/A |

Key: N/A = not applicable

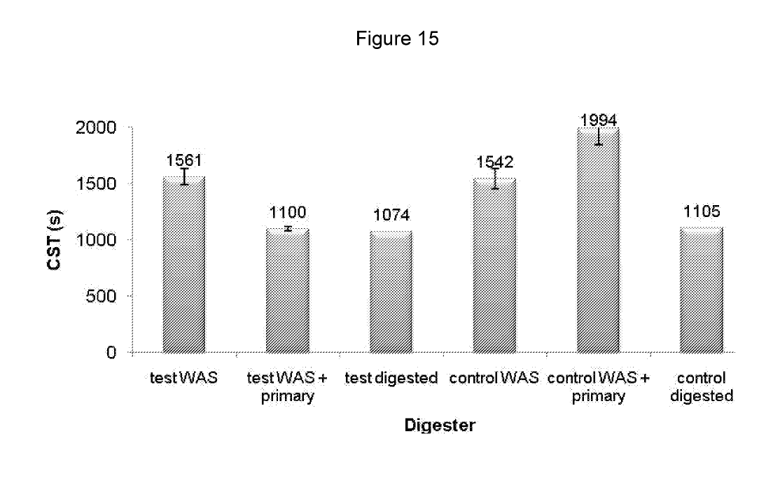

In relation to the effects on dewatering potential due to the pre-treatment carried out in the pilot scale system a reduction of 45% in the capillary suction time (CST) of test WAS+primary's digestate was observed in comparison with its control (FIG. 15), indicating a significant dewatering improvement. No significant effect was observed between the test WAS and test digested and the controls.

The pre-treatment operation in the pilot scale system is considered to be profitable if the increase of renewable energy (biogas) compensates for the energy consumption of the system. Thus, an initial energy balance was performed to quantify the net energy benefit associated with using devices like the PDX reactors in the pilot scale system as a pre-treatment for WAS sludge. The laboratory scale data were scaled up to a 2000 m³ digester with a sludge feed of 13000 l·d⁻¹. The main assumptions used to develop the energy balance were:
a) The lower heating value (LHV) of methane is 33.3 MJ·m³ (conversion to 20° C. and 1 atm of the 21518 Btu·lb⁻¹ reported by Avallone et al., (2007)).
b) The performance of the biogas combustion device was not considered. This will significantly decrease the energy available on the biogas.
c) The methane daily production of the laboratory scale digesters is linearly scalable to full scale.
d) The methane daily production considered was the obtained during the stable operational period of each laboratory scale digester (Table 5).

During all the trials, the PDX reactor(s) were operated at 8 bars with a steam mass flow rate of 0.029 kg·s⁻¹, whose specific energy was 2774 kJ·kg⁻¹. With these data and knowing that the increase of energy with the number of PDX reactors in series is linear, the 3 PDX system energy consumption was calculated, being 20509293 kJ·d⁻¹. However, a low intensity operation (80-84 L·min⁻¹) would produce a higher sludge quantity than the 13000 l·d⁻¹ to be fed to the digester. Thus, in Table 7 the PDX energy consumption was scaled as a function of the pre-treated sludge required to feed each digester.

TABLE 7
Energy balance of the 3 PDX reactor low intensity pre-treatment and a 2000
m³ digester with a feed of 13000 l · d⁻¹. (Values are averages of the replicates).

| | CH₄ | CH₄ | Lower | | | | | | |
|---|---|---|---|---|---|---|---|---|---|
| | daily production | daily production | heating | Estimated | PDX | Percentage of | Daily | Adjusted | Net |
| | in laboratory | in a 2000 m³ | value of | energy | energy | pre-treated | pre-treated | energy | energy |
| | digesters | digester | CH₄ | available | consumption | sludge into | sludge required | consumption | benefit |
| Digester | (m³ · d⁻¹) | (m³ · d⁻¹) | (MJ · m⁻³) | (MJ · d⁻¹) | (MJ · d⁻¹) | the digester | (l · d⁻¹) | (MJ · d⁻¹) | (kJ · d⁻¹) |
| test WAS | 3.21E−05 | 114.6 | 33.3 | 3815.1 | 20509.3 | 80 | 10400 | 1806.4 | 2009 |
| test WAS + | 1.29E−04 | 515.8 | 33.3 | 17174.9 | 20509.3 | 32 | 4160 | 722.5 | 16452 |
| primary | | | | | | | | | |

The energy balance was positive for test WAS and test WAS + primary implying that the methane production compensated for the PDX energy consumption.

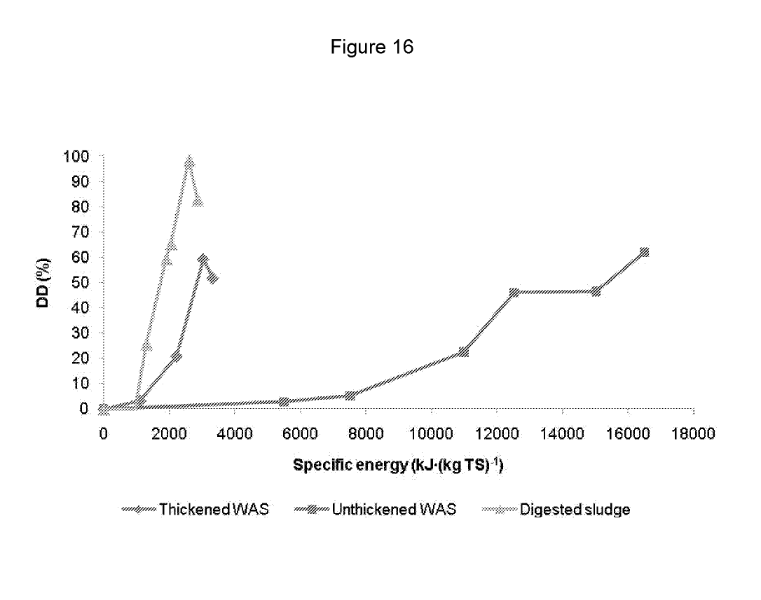

The absolute and specific energy consumptions of Table 8 and FIG. 16 were obtained considering the steam mass flow rate of 0.029 kg·s⁻¹, whose specific energy is 2774 kJ·kg⁻¹, and a linear increase of the consumption with the number of PDX reactors.

TABLE 8
Absolute and specific energy consumption of the PDX reactor during all the runs.

| | | Estimated | | | Energy | Specific energy | |
|---|---|---|---|---|---|---|---|
| | | flow rate | TS | TS flow rate | consumption | consumption | DD |
| | | (L · min⁻¹) | (g TS · l⁻¹) | (kg TS · s⁻¹) | (kJ · s⁻¹) | (kJ · (kg TS)⁻¹) | (%) |
| Thickened | 1 PDX | 80-84 | 52.102 | 7.12E−02 | 79 | 1109 | 3 |
| WAS | low | | | | | | |
| | intensity | | | | | | |
| | 2 PDXs | 80-84 | 52.102 | 7.12E−02 | 158 | 2219 | 21 |
| | low | | | | | | |
| | intensity | | | | | | |
| | 3 PDXs | 80-85 | 52.848 | 7.22E−02 | 237 | 3281 | 59 |
| | low | | | | | | |
| | intensity* | | | | | | |
| | 2 PDXs | 60 | 52.102 | 5.21E−02 | 158 | 3033 | 59 |
| | medium | | | | | | |
| | intensity** | | | | | | |
| Digested | 1 PDX | 80-84 | 60.651 | 8.29E−02 | 79 | 953 | 0 |
| sludge | low | | | | | | |
| | intensity | | | | | | |
| | 2 PDXs | 80-84 | 60.651 | 8.29E−02 | 158 | 1906 | 59 |
| | low | | | | | | |
| | intensity | | | | | | |
| | 3 PDXs | 80-84 | 60.651 | 8.29E−02 | 237 | 2859 | 83 |
| | low | | | | | | |
| | intensity* | | | | | | |
| | 1 PDX | 60 | 60.651 | 6.07E−02 | 79 | 1303 | 26 |
| | medium | | | | | | |
| | intensity | | | | | | |
| | 2 PDXs | 60 | 60.651 | 6.07E−02 | 158 | 2605 | 98 |
| | medium | | | | | | |
| | intensity | | | | | | |
| | 1 PDX | 38 | 60.651 | 3.84E−02 | 79 | 2057 | 65 |
| | high | | | | | | |
| | intensity | | | | | | |
| Unthickened | 1 PDX | 80-84 | 10.515 | 1.44E−02 | 79 | 5497 | 3 |
| WAS | low | | | | | | |
| | intensity | | | | | | |
| | 2 PDXs | 80-84 | 10.515 | 1.44E−02 | 158 | 10994 | 23 |
| | low | | | | | | |
| | intensity | | | | | | |
| | 3 PDXs | 80-84 | 10.515 | 1.44E−02 | 237 | 16492 | 62 |
| | low | | | | | | |
| | intensity | | | | | | |
| | 1 PDX | 60 | 10.515 | 1.05E−02 | 79 | 7513 | 5 |
| | medium | | | | | | |
| | intensity | | | | | | |
| | 2 PDXs | 60 | 10.515 | 1.05E−02 | 158 | 15026 | 46 |
| | medium | | | | | | |
| | intensity | | | | | | |
| | 1 PDX | 36 | 10.515 | 6.31E−03 | 79 | 12521 | 46 |
| | high | | | | | | |
| | intensity | | | | | | |

Key:
*= values average of two runs;
**= values obtained during the second operational period of the PDX reactor

The DD of all the sludges increased significantly with a higher specific energy applied by the pre-treatment (Table 8 and FIG. 16). This trend is not followed with the highest specific energy applied for TWAS and digested sludge. However, those two data are the average of two runs, which may have caused this change of trend. It is observed that the highest performance was obtained for digested sludge and followed by the TWAS, which achieved a higher DD with a much lower specific energy input than the unthickened WAS.

It was observed that thickened WAS, unthickened WAS and digested sludge showed an increased biodegradability with the PDX pre-treatment, both quantified as normalized (FIG. 11) and absolute sCOD. The thickened WAS sCOD/TS was increased from 5 mg·g⁻¹ to 180 mg·g⁻¹ when treated with a 3 PDX low intensity pre-treatment and the digested sludge and unthickened WAS achieved up to 135 mg·g⁻¹ with initial values of 75 and 4 mg·g¹, respectively.

The highest absolute sCOD was achieved after a 3 PDXs low intensity pre-treatment of TWAS (8711.3 mg·l⁻¹, average of two runs), with a 4367% increase compared to the untreated sludge. This increase is much higher than the 25-60% reported by (Climent et al., 2007) after a thermal pre-treatment at 130-170° C. or the 340% obtained by (Erden & Filibeli, 2010) with an ultrasound mechanical system. Do\check{g}an & Sanin, (2009) achieved sCOD changes in waste activated sludge from 50 to 4000 mg·l⁻¹ with a combined microwave+NaOH pre-treatment and from 50 to 2300 mg·l⁻¹ with just the chemical treatment. Both represent a higher percentage of increase but reached lower absolute values. Only two references have been found in the literature highlighting an equivalent or better performance than the system including the PDX reactors: Bougrier et al., (2007) achieved an increase in sCOD from 700 to 8500 mg·l⁻¹ after an ozone pre-treatment with a dose of 0.18 g O₃ g⁻¹ TS and Kampas et al., (2010) reported a sCOD increase from 1198 to 14320 mg·l⁻¹ with a mechanical device.

The highest DD was obtained for the digested sludge (up to 83%). These results highlighted that the PDX pre-treatment was able to release the majority of the sCOD confined within the digested sludge's agglomerates and to cause a level of cell lysis similar to that obtainable by the theoretical maximum alkaline hydrolysis. The DD achieved for WAS (up to 59%) and TWAS (up to 62%) were not as high as for digested sludge, but still equivalent or higher than the 58% reported by (Erden & Filibeli, 2010) with an ultrasound device. It is noteworthy that the digested sludge, WAS and TWAS treated with a 3 PDXs low intensity pre-treatment achieved a DD higher than the 40% reported by (Huan et al., 2009) as the threshold for cell lysis.

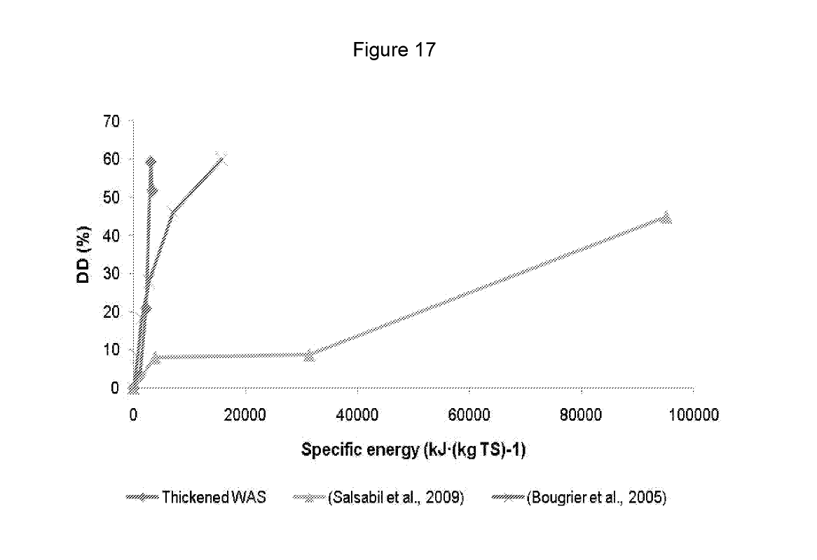

Considering FIG. 16, it can be concluded that the pilot scale system with the PDXs achieved high DD percentages with low specific energy intensities for digested sludge and TWAS. However, the DD for unthickened WAS was low for energy levels below 11000 kJ·(kg TS)⁻¹. When compared with values reported in the literature for ultrasonic pre-treatments (Salsabil et al., 2009, Bougrier et al., 2005), the PDX pre-treatment requires a lower specific energy input for achieving high DD with thickened WAS, as shown in FIG. 17. The comparison was completed with ultrasonic pre-treatments due to the unavailability of data for thermal devices.

The pilot scale system obtained its lowest performance with the primary sludge, which, despite achieving the highest sCOD normalized with respect to the TS (FIG. 10), did not show a significant increase in its organic matter solubilization (FIG. 11). This is in agreement with Carrère et al., (2010), which defines primary sludge as already readily degradable, thus making a pre-treatment prior to an anaerobic digestion process less effective. Bougrier et al., (2008) asserts “the lower the initial biodegradability, the higher is the impact of thermal treatment”. The alkaline hydrolysis test appeared to confirm this fact by not solubilizing a relevant amount of COD of the primary sludge.

As far as the effect of operational conditions on the PDX performance is concerned, two methods of increasing the applied energy where studied: higher number of units in series and lower sludge flow rate. The TWAS, WAS and digested sludge behaved in a similar manner, increasing their sCOD/TS with a higher number of PDX reactors. However, no benefit was observed when reducing the sludge flow rate, except for the WAS when passing from 60 to 38-36 L·min⁻¹.

Due to the high sCOD and DD achieved for TWAS pre-treated with 3 PDXs at low intensity, two digesters with this sludge and two with a mix of pre-treated TWAS and raw primary were established to mimic feeds typical to anaerobic digesters in full scale plants. A fifth test was implemented with pre-treated digested sludge to assess the possible benefit of installing the pre-treatment in a full scale digester's recirculation loop.

The methane potential tests showed the requirement of an acclimation period of 11, 23 and 8 days for test WAS, test WAS+primary and test digested, respectively, before the digesters reached a stable operational period. This lag phase was much longer than the 3 days reported by Weemaes, (2000), which may indicate that an acclimation of the inoculum before its use would have been appropriate, as in other studies (Do\check{g}an & Sanin, 2009, Eskicioglu et al., 2009). “The acclimation has a significant effect on the maximum specific utilization rates of various compounds and on their apparent consumption kinetics” (Gavala & Lyberatos, 2001).

During the stable operational periods the best performance was obtained for the test WAS, which produced biogas with methane content 5% higher (68.1%) and had a normalized methane daily production 71% higher than its control. The average methane content (68.1%), is in accordance with other thermal pre-treatments: 65 to 71% according to Eskicioglu et al., (2009) and 71% reported by Bougrier et al., (2006). Test WAS+primary achieved higher CH₄ contents (81%) and normalized daily production (4.9E-03 m³·(kg VS_{fed}·d)⁻¹), but its relative benefit over the control was lower (4% and 41%, respectively).

Despite the tests' better daily methane production during the stable operational periods, both control WAS and control WAS+primary achieved a higher normalized cumulative biogas production than their tests (Table 5). This is not comparable with the results found in literature of other thermal pre-treatments. As highlighted in Table 5 the biogas production of test WAS+primary was 160 L·(kg VS_{feed})⁻¹, and that of test WAS 150 L·(kg VS_{feed})⁻¹. These values do not reach the figures reported in the literature: 300 L·(kg VS_{feed})⁻¹ for a biological pre-treatment (Hasegawa et al., 2000), 32% increase over controls after a thermal process (Kim et al., 2003).

Not wishing to be bound by a particular theory, we believe the cause for the lack of improvement in the cumulative biogas and methane production is that the digesters were overloaded. There were two main aspects which affected the feed to the reactors: (a) the PDX pre-treatment operated better in terms of sCOD release during the second run than expected according to the results of the first run (See, e.g., Tables 10, 12, and 15) and (b) the primary sludge used for the feed preparation was a cake instead of the sludge with low solids contents characterized in the first part of the project (See, e.g., Tables 4 and 11).

The TVFA results verified that the digesters were overloaded, as reported by Climent et al., (2007). According to Cartmell & Chinaglia, (2009) a TVFA content of around 500 mg·l⁻¹ is normal for a conventional digester, while fully adapted and carefully controlled reactors can operate with concentrations up to 5000 mg·l⁻¹. The feeds used for loading the laboratory digesters had TVFA concentrations between 2134 and 13019 mg·l⁻¹ (Table 5). This likely inhibited the methanogenic activity because of a lack of enough alkalinity to buffer the high acid concentrations. It is assumed that if the digester had not been overloaded, then the cumulative biogas production of the tests should have been significantly higher than that of the controls. This is because the pre-treatment achieved a high sCOD, DD and particle size reduction, which correlates with increased methane production (see, e.g., Fdz-Polanco et al. (2008), Eskicioglu et al. (2009), Bougrier et al. (2008), Bougrier et al. (2006)). In addition, the test digesters reached a stable operational period in which the methane content and biogas daily production was significantly higher than that of the controls. If this period was extended, for instance by acclimatizing the inoculum, the overall cumulative biogas production would be improved. This benchmarks the PDX pre-treatment's performance favorably against current commercial units. This is verified when comparing the 31.2 ml CH₄/(g sCOD·d)⁻¹ production of test WAS+primary (equivalent to the data 4.9E-03 m³ CH₄·(kg VS_{fed}·d)⁻¹ of Table 5) with the 22.9 ml CH₄/(g sCOD·d)⁻¹ reported by Weemaes (2000) for a mix of primary and WAS sludge. Finally, the 3 PDX pre-treatment achieved a much higher TVFA release for TWAS (39921% increase) than other thermal pre-treatments found in literature (increases up to 2078%, Climent et al. (2007)). This high TVFA concentration was not expected during the project, thus leading to the digester overload. However, this high TVFA release of the system with the PDXs when compared with other commercialized units, may be an advantage if controlled. The number of PDXs in series and the flow rate may be adjusted to obtain the optimal TVFA concentration for the digesters of each STW, without upper limitations.

As for the sludge quantity reduction, the best VS removal was that of test WAS (45.5%).

In addition to the performance benefit associated with the PDX pre-treatment, it also has some important design and operational advantages over other processes:
1) Fast processing times. The unit was operated with throughputs of 36-84 l·min⁻¹, which implies treatment times significantly lower than the 30-60 min usually reported for thermal processes at 160-180° C. (Bougrier et al. (2008), the 60 s of (Dohányos et al. (2004) or the up to 7 days of (Gavala et al. (2003).
2) Lower final temperatures (maximum ΔT=49.1° C.) than the reported 160-200° C. suggested by (Bougrier et al. (2008), Carrère et al. (2010) for other thermal pre-treatments.
3) Fully scalable. Unlike other technologies, the number of PDXs in series can vary according to the necessities of each STW.

The initial energy balance developed with the 3 PDX pilot scale system consumption and the digesters methane daily production, showed that a benefit up to 16.5 MJ·d⁻¹ could be expected in a 2000 m³ digester fed with 13000 l·d⁻¹ of a pre-treated WAS and un-pre-treated primary sludge mix. However, a higher biogas production was prevented due to the overloading of the digesters which was not associated with the PDX pre-treatment itself. Thus, with a correct loading, much higher energy recoveries should be expected.

The main conclusions drawn from the data presented herein are:
1) Pre-treatment with a device, such as a PDX reactor, effectively solubilized organic material from the sludge, leading to significant increases of the absolute and normalised sCOD. All this increased the biodegradability of the material to enable enhancement of the AD digestion process. The best results were obtained for thickened WAS, with over 4000% increase in the sCOD.
   This >4000% increase with the PDX reactor pre-treatment technology is much higher than the 25-60% reported by Climent et al. (2007) after a thermal pre-treatment at 130-170° C. or the 340% obtained by Erden & Filibeli (2010) with an ultrasound mechanical system. Only two documents have been found in the literature highlighting an equivalent or better performance using completely different systems than the present system with the PDXs: Bougrier et al. (2007) achieved an increase in sCOD from 700 to 8500 mg·l⁻¹ after an ozone pre-treatment with a dose of 0.18 g O₃·g⁻¹ TS and Kampas et al. (2010) reported a sCOD increase from 1198 to 14320 mg·l⁻¹ with a mechanical device.
2) The pilot scale system achieved its optimum performance when operated with 3 PDX reactors in series and at low intensity (80-84 l·min⁻¹). It was concluded that the effect of the number of units was greater than that of a higher intensity (reduced flow rate).
3) The PDX reactor pre-treatment was found to be better in terms of specific energy consumption for sCOD release when compared with ultrasonic pre-treatments. Values of DD of 60% and 98% were obtained with less than 3300 kJ·(kgTS)⁻¹ for TWAS and digested sludge, respectively. Higher energy demands were required when treating unthickened WAS, whose DD did not increase significantly with specific energies below 11000 kJ·(kgTS)⁻¹.
   When compared with values reported in literature for ultrasonic pre-treatments (Salsabil et al., 2009, Bougrier et al., 2005), the PDX pre-treatment required a lower specific energy input for achieving high DD with thickened WAS, as shown in FIG. 17. The comparison was completed with ultrasonic pre-treatments due to the unavailability of data for thermal devices.
4) The pre-treated material was anaerobically digested and could achieve a maximum improvement in the daily methane production normalised per VS of 71% 41% and 29% for tests WAS, test WAS+primary and test digested respectively.
5) The dewaterability of the digestates containing pre-treated material was better or equal to that with un-pre-treated sludges.

### Analysis of Solids

Table 9 below includes a summary of the solids content of all the sludges used during the project, both before and after the PDX reactor pre-treatment.

TABLE 9
TS and VS concentrations of all the sludges used during the
project, both before and after the PDX reactor pre-treatment.

| | | | |
|---|---|---|---|
| | | | % DS by |
| Sludge | TS (g · l⁻¹) | VS (g · l⁻¹) | weight |

FIRST RUN

| | | | |
|---|---|---|---|
| TWAS raw | 49.3 | 30.2 | 4.93 |
| TWAS 1 PDX low | 48.8 | 35.0 | 4.88 |
| intensity | | | |
| TWAS 2 PDXs low | 47.1 | 29.3 | 4.71 |
| intensity | | | |
| TWAS 3 PDXs low | 47.3 | 33.3 | 4.73 |
| intensity | | | |
| Primary sludge raw | 1.1 | 0.4 | 0.11 |
| Primary sludge 1 | 1.2 | 0.7 | 0.12 |
| PDX low intensity | | | |
| Primary sludge 2 | 1.1 | 0.6 | 0.11 |
| PDXs low intensity | | | |
| Primary sludge 3 | 1.0 | 0.5 | 0.10 |
| PDXs low intensity | | | |
| Primary sludge 1 | 1.0 | 0.7 | 0.10 |
| PDX medium intensity | | | |
| Primary sludge 2 | 0.9 | 0.7 | 0.09 |
| PDXs medium intensity | | | |
| Digested sludge raw | 60.7 | 37.9 | 6.07 |
| Digested sludge 1 | 57.6 | 24.5 | 5.76 |
| PDX low intensity | | | |
| Digested sludge 2 | 54.8 | 34.4 | 5.48 |
| PDXs low intensity | | | |
| Digested sludge 3 | 57.0 | 34.2 | 5.70 |
| PDXs low intensity | | | |
| Digested sludge 1 | 56.2 | 34.5 | 5.62 |
| PDX medium intensity | | | |
| Digested sludge 2 | 57.9 | 31.9 | 5.79 |
| PDXs medium intensity | | | |
| Digested sludge 1 | 58.0 | 30.1 | 5.80 |
| PDX high intensity | | | |
| Unthickened WAS raw | 10.5 | 7.6 | 1.05 |
| Unthickened WAS 1 | 10.5 | 7.0 | 1.05 |
| PDX low intensity | | | |
| Unthickened WAS 2 | 9.8 | 6.7 | 0.98 |
| PDXs low intensity | | | |
| Unthickened WAS 3 | 9.8 | 6.8 | 0.98 |
| PDXs low intensity | | | |
| Unthickened WAS 1 | 10.1 | 6.8 | 1.01 |
| PDX medium intensity | | | |
| Unthickened WAS 2 | 10.0 | 6.7 | 1.00 |
| PDXs medium intensity | | | |
| Unthickened WAS 1 | 9.8 | 6.7 | 0.98 |
| PDX high intensity | | | |

SECOND RUN

| | | | |
|---|---|---|---|
| Primary raw | 90.8 | 71.1 | 9.08 |
| WAS raw | 53.6 | 26.2 | 5.36 |
| WAS 2 PDXs medium | 49.8 | 34.0 | 4.98 |
| intensity | | | |
| WAS 3 PDXs low | 49.4 | 35.1 | 4.94 |
| intensity | | | |
| Digested raw | 58.4 | 37.2 | 5.84 |
| Digested 3 PDXs low | 55.5 | 35.3 | 5.55 |
| intensity | | | |

The sCOD concentrations of the different pre-treated and un-pre-treated sludges, both absolute and normalized in terms of their TS content, were analyzed. The sCOD concentrations after the alkaline hydrolysis of the sludges used for the first set of runs of the rig are also included.

### PDX Reactor Pre-Treatment Energy Consumption

The energy consumption of the PDX when operated with different steam pressures are shown below in Table 10.

TABLE 10
Energy consumption of the PDX reactor when operated with different steam pressures

| Pₒ, barg | 10.00 | 9.00 | 8.00 | 7.00 | 6.00 |
|---|---|---|---|---|---|
| Pₒ, bar | 11.01 | 10.01 | 9.01 | 8.01 | 7.01 |
| Tₒ, C | 184.10 | 179.90 | 175.40 | 170.40 | 165.00 |
| υₒ, m³/kg | 0.177 | 0.194 | 0.215 | 0.240 | 0.273 |
| Pₜₕᵣₒₐₜ, bar | 6.36 | 5.78 | 5.20 | 4.63 | 4.05 |
| Tₜₕᵣₒₐₜ, K | 432 | 429 | 425 | 421 | 417 |
| υₜₕᵣₒₐₜ, m³/kg | 0.288 | 0.315 | 0.349 | 0.390 | 0.443 |
| mass flow rate, kg/s | 0.394 | 0.359 | 0.324 | 0.289 | 0.254 |
| mass flow rate, kg/min | 23.7 | 21.6 | 19.4 | 17.3 | 15.2 |
| P_{b}, barg | 0.01 | 0.01 | 0.01 | 0.01 | 0.01 |
| P_{b}, bar | 1.02 | 1.02 | 1.02 | 1.02 | 1.02 |
| h_{g}, kJ/kg | 2,781 | 2,778 | 2,774 | 2,769 | 2,764 |
| steam energy rate, kJ/s | 1097 | 998 | 899 | 800 | 701 |
| KJ/day | 94750166 | 86212293 | 77682986 | 69142745 | 60599739 |
| Mj/day | 94750 | 86212 | 77683 | 69143 | 60600 |
| 2 PDXs system Kj/day | 189500332 | 172424587 | 155365973 | 138285491 | 121199478 |
| 2 PDXs system Mj/day | 189500 | 172425 | 155366 | 138285 | 121199 |
| 3 PDXs system Kj/day | 284250498 | 258636880 | 233048959 | 207428236 | 181799217 |
| 3 PDXs system Mj/day | 284250 | 258637 | 233049 | 207428 | 181799 |

| Pₒ, barg | 5.00 | 4.00 | 3.00 | 2.00 |
|---|---|---|---|---|
| Pₒ, bar | 6.01 | 5.01 | 4.01 | 3.01 |
| Tₒ, C | 158.80 | 151.80 | 143.60 | 133.50 |
| υₒ, m³/kg | 0.316 | 0.375 | 0.462 | 0.606 |
| Pₜₕᵣₒₐₜ, bar | 3.47 | 2.89 | 2.32 | 1.74 |
| Tₜₕᵣₒₐₜ, K | 408 | 403 | 398 | 388 |
| υₜₕᵣₒₐₜ, m³/kg | 0.512 | 0.608 | 0.750 | 0.983 |
| mass flow rate, kg/s | 0.218 | 0.183 | 0.147 | 0.112 |
| mass flow rate, kg/min | 13.1 | 11.0 | 8.8 | 6.7 |
| P_{b}, barg | 0.01 | 0.01 | 0.01 | 0.01 |
| P_{b}, bar | 1.02 | 1.02 | 1.02 | 1.02 |
| h_{g}, kJ/kg | 2,757 | 2,749 | 2,739 | 2,725 |
| steam energy rate, kJ/s | 602 | 503 | 404 | 304 |
| KJ/day | 52037551 | 43473718 | | |
| Mj/day | 52038 | 43474 | | |
| 2 PDXs system Kj/day | 104075102 | 86947435 | | |
| 2 PDXs system Mj/day | 104075 | 86947 | | |
| 3 PDXs system Kj/day | 156112653 | 130421153 | | |
| 3 PDXs system Mj/day | 156113 | 130421 | | |

### CITED DOCUMENTS

APHA. (2005). Standard methods for the examination of water and wastewater (21st ed.). Washington: American Public Health Association
Abelleira, J., Pérez-Elvira, S. I., Sánchez-Oneto, J., Portela, J. R., & Nebot, E. (2011). Advanced Thermal Hydrolysis of secondary sewage sludge: A novel process combining thermal hydrolysis and hydrogen peroxide addition. Resources, Conservation and Recycling, 1-5. (Article in press: doi:10.1016/j.resconrec.2011.03.008)
Appels, L., Baeyens, J., Degrève, J., & Dewil, R. (2008). Principles and potential of the anaerobic digestion of waste-activated sludge. Progress in Energy and Combustion Science, 34(6), 755-781
Avallone, E. A., Baumeister, T., & Sadegh, A. M. (2007). Marks' standard handbook for mechanical engineers (11th ed.). McGraw-Hill
Bouallagui, H., Marouani, L., & Hamdi, M. (2010). Performances comparison between laboratory and full-scale anaerobic digesters treating a mixture of primary and waste activated sludge. Resources, Conservation and Recycling, 55(1), 29-33
Bougrier, C, Albasi, C., Delgenès, J., & Carrère, H. (2006). Effect of ultrasonic, thermal and ozone pre-treatments on waste activated sludge solubilization and anaerobic biodegradability. Chemical Engineering and Processing, 45(8), 711-718
Bougrier, C., Carrère, H., & Delgenès, J. P. (2005). Solubilisation of waste-activated sludge by ultrasonic treatment. Chemical Engineering Journal, 106(2), 163-169
Bougrier, C., Delgenès, J. P., & Carrère, H. (2008). Effects of thermal treatments on five different waste activated sludge samples solubilization, physical properties and anaerobic digestion. Chemical Engineering Journal, 139(2), 236-244
Bougrier, C., Delgenès, J. P., & Carrère, H. (2007). Impacts of thermal pre-treatments on the semi-continuous anaerobic digestion of waste activated sludge. Biochemical Engineering Journal, 34(1), 20-27
Bougrier, C., Battimelli, A., Delgenès, J.-P., & Carrère, H. (2007). Combined Ozone Pretreatment and Anaerobic Digestion for the Reduction of Biological Sludge Production in Wastewater Treatment. Ozone: Science & Engineering, 29(3), 201-206
Carrère, H, Dumas, C., Battimelli, A, Batstone, D J, Delgenès, J P, Steyer, J P, & Ferrer, I. (2010). Pretreatment methods to improve sludge anaerobic degradability: A review. Journal of hazardous materials, 183(1-3), 1-15
Cartmell, E., & Chinaglia, F. A. (2009). Digester Foaming Assessment at Southern Water. Commercial report to Southern Water
Climent, M., Ferrer, I., Baeza, M. M., Artola, A., Vázquez, F., & Font, X. (2007). Effects of thermal and mechanical pretreatments of secondary sludge on biogas production under thermophilic conditions. Chemical Engineering Journal, 133(1-3), 335-342
Degremont Technologies. (2011). Biolysis O—Sludge Reduction Technology. Accessed on 20 Aug. 2011, from http://www.degremont-technologies.com/dgtech.php?rubrique34
Dohányos, M., Zábranská, J., Kutil, J., & Jenícek, P. (2004). Improvement of anaerobic digestion of sludge. Water science and technology, 49(10), 89-96
Do\check{g}an, I., & Sanin, F. D. (2009). Alkaline solubilization and microwave irradiation as a combined sludge disintegration and minimization method. Water research, 43(8), 2139-2148
Dubois, M., Gilles, K. A., Hamilton, J. K., Rebers, P. A, & Smith, F. (1956). Colorimetric Method for Determination of Sugars and Related Substances. Analytical Chemistry, 28(3), 350-356
Ecosolids International. (2011). Cellruptor. Accessed on 15 Aug. 2011, from http://www.ecosolids.com/products/cellruptor/Erden,
G., & Filibeli, A. (2010). Ultrasonic pre-treatment of biological sludge: consequences for disintegration, anaerobic biodegradability, and filterability. Journal of Chemical Technology & Biotechnology, 85(1), 145-150
Eskicioglu, C., Kennedy, K. J., & Droste, R. L. (2009). Enhanced disinfection and methane production from sewage sludge by microwave irradiation. Desalination, 248(1-3), 279-285
Eskicioglu, C., Terzian, N., Kennedy, K. J, Droste, R. L, & Hamoda, M. (2007). Athermal microwave effects for enhancing digestibility of waste activated sludge. Water research, 41(11), 2457-2466
Fang, Herbert H. P., Li, Y. Y & Chui, H. K. (1995) Performance and sludge characteristics of UASB process treating propionate-rich wastewater. Water Research, 29(3), 895-898.
Fdz-Polanco, F., Velazquez, R., Perez-Elvira, S. I., Casas, C., del Barrio, D., Cantero, F. J., Fdz-Polanco, M., Rodriguez P., Panizo L., Serrat J. & Rouge P. (2008). Continuous thermal hydrolysis and energy integration in sludge anaerobic digestion plants. Water science and technology, 57(8), 1221-1226
Frolund, B., Griebe, T., & Nilesen, H. P. (1995). Enzymatic activity in the activated-sludge floc matrix. Applied microbiology and biotechnology, 43(4), 755-761
Gavala, H. N, & Lyberatos, G. (2001). Influence of anaerobic culture acclimation on the degradation kinetics of various substrates. Biotechnology and bioengineering, 74(3), 181-195
Gavala, H. N, Yenal, U., Skiadas, I. V., Westermann, P., & Ahring, B. K. (2003). Mesophilic and thermophilic anaerobic digestion of primary and secondary sludge. Effect of pre-treatment at elevated temperature. Water research, 37(19), 4561-4572
Ge, H., Jensen, P. D., & Batstone, D. J. (2011). Temperature phased anaerobic digestion increases apparent hydrolysis rate for waste activated sludge. Water research, 45(4), 1597-1606
Hasegawa, S., Shiota, N., Katsura, K., & Akashi, A. (2000). Solubilization of organic sludge by thermophilic aerobic bacteria as a pretreatment for anaerobic digestion. Water science and technology, 41(3), 163-169
Huan, L., Yiying, J., Mahar, R. B., Zhiyu, W., & Yongfeng, N. (2009). Effects of ultrasonic disintegration on sludge microbial activity and dewaterability. Journal of hazardous materials, 161(2-3), 1421-1426
Kampas, P., Parsons, S. A., Pearce, P., Ledoux, S., Vale, P., Churchley, J., & Cartmell, E. (2010). Mechanical Sludge Disintegration: Providing an Alternative Carbon Source for Nutrient Removal. Environmental Technology, 28, 471-477
Kampas, P., Parsons, S. A, Pearce, P., Ledoux, S., Vale, P., Churchley, J., & Cartmell, E. (2007). Mechanical sludge disintegration for the production of carbon source for biological nutrient removal. Water research, 41(8), 1734-1742
Khanal, S. K., Grewell, D., Sung, S., & Van Leeuwen, J. (2007). Ultrasound Applications in Wastewater Sludge Pretreatment: A Review. Critical Reviews in Environmental Science and Technology, 37(4), 277-313
Kim, J., Park, C., Kim, T. H., Lee, M., Kim, S., Kim, S. W., & Lee, J. (2003). Effects of various pretreatments for enhanced anaerobic digestion with waste activated sludge. Journal of bioscience and bioengineering, 95(3), 271-275
Mottet, A., François, E., Latrille, E., Steyer, J. P., Déléris, S., Vedrenne, F., & Carrère, Hélène. (2010). Estimating anaerobic biodegradability indicators for waste activated sludge. Chemical Engineering Journal, 160(2), 488-496
Müller, J. (2000). Disintegration as a key-step in sewage sludge treatment. Water Science and Technology, 41(8), 123-130
Nah, I., Kang Y. W., Hwang K. Y. & Song W. K. (2000). Mechanical pretreatment of waste activated sludge for anaerobic digestion process. Water Research, 34(8), 2362-2368
Pursuit Dynamics plc. (2011). Commercial brochure
Perez-Elvira, S. I., Nieto Diez, P., & Fdz-Polanco, F. (2006). Sludge minimisation technologies. Reviews in Environmental Science and Bio/Technology, 5(4), 375-398
Salsabil, M. R., Prorot, A., Casellas, M., & Dagot, C. (2009). Pre-treatment of activated sludge: Effect of sonication on aerobic and anaerobic digestibility. Chemical Engineering Journal, 148(2-3), 327-335
Valo, A., Carrère, H., & Delgenès, J. P. (2004). Thermal, chemical and thermo-chemical pre-treatment of waste activated sludge for anaerobic digestion. Journal of Chemical Technology & Biotechnology, 79(11), 1197-1203
Volgelsang. (2011). Accessed on 15 Aug. 2011, from http://www.engineered-to-work.com/en/BioCrack_Productinformation.html
Weemaes, M. (2000). Anaerobic digestion of ozonized biosolids. Water Research, 34(8), 2330-2336
All documents cited in this application are hereby incorporated by reference as if recited in full herein.

Although illustrative embodiments of the present invention have been described herein, it should be understood that the invention is not limited to those described, and that various other changes or modifications may be made by one skilled in the art without departing from the scope or spirit of the invention.

What is claimed is:

1. A method of increasing soluble chemical oxygen demand (sCOD) in sewage sludge comprising:
(i) passing the sewage sludge through one or more devices that comprise:
(a) a hollow body provided with a straight-through passage of substantially constant cross-section, the passage having an inlet end and an outlet end for the entry and discharge, respectively, of the sewage sludge,
(b) a transport fluid nozzle substantially circumscribing and opening into the passage intermediate the inlet and outlet ends thereof,
(c) a transport fluid inlet communicating with the transport fluid nozzle for the introduction of a transport fluid, and
(d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle, wherein the sCOD of the sewage sludge is increased by up to 3,000-4,000% after step (i) compared to the sCOD of the sewage sludge prior to step (i); and
(ii) passing the sewage sludge from step (i) through a digester.

2. The method according to claim 1, wherein a flow rate of the sewage sludge through the one or more devices is less than about 86 L/minute.

3. The method according to claim 2, wherein a flow rate of the sewage sludge through the one or more devices is about 40 L/minute.

4. The method according to claim 1, wherein a temperature of the sewage sludge through the one or more devices is between about 35-100° C.

5. The method according to claim 1, wherein a temperature of the sewage sludge through the one or more devices is between about 55° C. and 60° C.

6. The method according to claim 4, wherein a temperature of the sewage sludge through the one or more devices is about 78° C.

7. The method according to claim 1, wherein step (i) comprises passing the sewage sludge through one to four devices prior to step (ii).

8. The method according to claim 7, wherein step (i) comprises passing the sewage sludge through four devices prior to step (ii).

9. The method according to claim 1, wherein each device is an in-line reactor.

10. The method according to claim 1, wherein the transport fluid is a fluid or a gas.

11. The method according to claim 10, wherein the transport fluid is compressible.

12. The method according to claim 10, wherein the transport fluid is selected from the group consisting of water, air, nitrogen, helium, carbon dioxide, and steam.

13. The method according to claim 12, wherein the transport fluid is steam.

14. The method according to claim 12, wherein the transport fluid is compressed air.

15. The method according to claim 1, wherein the digester is an anaerobic digester.

16. The method according to claim 15, wherein the sewage sludge is primary sludge.

17. The method according to claim 15, wherein the sewage sludge is waste activated sludge.

18. The method according to claim 15, wherein the sewage sludge is a blend of primary sludge and waste activated sludge.

19. The method according to claim 16 further comprising generating an increase in methane production of about 70% compared to the method in the absence of the devices.

20. The method according to claim 17 further comprising generating an increase in methane production of about 30% compared to the method in the absence of the devices.

21. The method according to claim 1, wherein the digester is an aerobic digester.

22. The method according to claim 1 in which the sewage sludge is converted to Class A sludge.

23. The method according to claim 1, further comprising reducing odor-causing agents from the sewage sludge compared to a method in the absence of the devices.

24. The method according to claim 23, wherein ammonia is separated from the odor-causing agents.

25. The method according to claim 1, wherein the dewaterability of the sewage sludge is increased by at least about 1% compared to a method in the absence of the devices.

26. The method according to claim 1 further comprising passing the post-digester sewage sludge through at least one of the devices and returning it to the digestor.

27. The method according to claim 1 further comprising:
(i) (d) blending the sewage sludge from step (c) with a sludge selected from the group consisting of WAS, primary sludge, and a blend of WAS and primary sludge; and
(e) returning the blend from step (d) to the digestor.

28. The method according to claim 1 further comprising passing the post-digestor sewage sludge through at least one of the devices prior to dewatering to increase the dewaterability.

29. A method of providing a waste water stream with a sCOD level that is increased by at least about 100% compared to a waste water stream in the absence of step (i) to an anaerobic digester comprising:
(i) passing the waste water stream through one or more devices that comprise:
(a) a hollow body provided with a straight-through passage of substantially constant cross-section, the passage having an inlet end and an outlet end for the entry and discharge respectively of the waste water,
(b) a transport fluid nozzle substantially circumscribing and opening into the passage intermediate the inlet and outlet ends thereof,
(c) a transport fluid inlet communicating with the transport fluid nozzle for the introduction of a transport fluid, and
(d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water stream in the mixing chamber by the introduction of the transport fluid through the transport fluid nozzle, wherein the sCOD of the waste water stream is increased at least about 100% compared to a waste water stream in the absence of step (i); and
(ii) providing the waste water from step (i) to the anaerobic digester.

30. A method of increasing methane production in an anaerobic waste water processing system comprising:
(i) providing (a) a waste water processing plant comprising a primary settling tank, a secondary settling tank, and an anaerobic digester, each of which is directly or indirectly in fluid communication and (b) one or more devices disposed within the waste water processing plant;
(ii) passing the waste water through the one or more devices, each device comprising:
(a) a hollow body provided with a straight-through passage of substantially constant cross-section, the passage having an inlet end and an outlet end for the entry and discharge respectively of the waste water,
(b) a transport fluid nozzle substantially circumscribing and opening into the passage intermediate the inlet and outlet ends thereof,
(c) a transport fluid inlet communicating with the transport fluid nozzle for the introduction of a transport fluid, and
(d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the waste water flow in the mixing chamber by the introduction of the transport fluid through the transport fluid nozzle, wherein organic material in the waste water is substantially disintegrated;
(iii) passing the waste water from step (ii) through the anaerobic digester; and
(iv) collecting methane produced in the anaerobic digester, wherein the amount of methane collected is at least 30% greater compared to a waste water processing plant without the devices.

31. A system for treating sewage sludge comprising:
(i) a waste water processing plant comprising a primary settling tank, a secondary settling tank, and an anaerobic digester, each of which is directly or indirectly in fluid communication and four devices disposed within the waste water processing plant, each device comprising:
(a) a hollow body provided with a straight-through passage of substantially constant cross-section, the passage having an inlet end and an outlet end for the entry and discharge respectively of the sewage sludge,
(b) a transport fluid nozzle substantially circumscribing and opening into the passage intermediate the inlet and outlet ends thereof,
(c) a transport fluid inlet communicating with the transport fluid nozzle for the introduction of a transport fluid, and
(d) a mixing chamber being formed within the passage downstream of the transport fluid nozzle, the transport fluid nozzle being of convergent-divergent geometry internally thereof such as in use to provide for the generation of supersonic flow of the transport fluid therein, and the transport fluid nozzle and mixing chamber being so disposed and configured that in use a dispersed droplet flow regime and a supersonic shockwave are created within the mixing chamber by the introduction of the transport fluid through the transport fluid nozzle and subsequent condensation thereof and whereby a pseudo convergent-divergent section is created in the sewage sludge flow in the mixing chamber by the introduction of the transport fluid through the transport fluid nozzle,
wherein the devices increase the soluble chemical oxygen demand (sCOD) in the sewage sludge by up to 3,000-4,000% compared to a system in the absence of the device(s) prior to passing the sewage sludge to the digester.
